(19) United States
(12) Patent Application Publication
(10) Pub. No.: US 2008/0136795 A1
(43) Pub. Date: Jun. 12, 2008

(54) Display Device and Driving Method Thereof

(76) Inventors: Takaji Numao, Nara (JP); Akira Tagawa, Nara (JP)

Correspondence Address: HARNESS, DICKEY & PIERCE, P.L.C., P.O. BOX 8910, RESTON, VA, 20195, US

(21) Appl. No.: 11/795,305

(22) PCT Filed: Nov. 16, 2005
(86) PCT No.: PCT/JP05/21057

§ 371 Date: Jul. 16, 2007

(30) Foreign Application Priority Data
Mar. 25, 2005 (JP) 2005-089952
Aug. 26, 2005 (JP) 2005-246831

(51) Int. Cl. G06F 3/038

(52) U.S. Cl. 345/204

(57) ABSTRACT

In a pixel circuit Aij, a driver TFT Q1, a switching TFT Q3, and an OLED EL1 are connected in series between a power supply line Vp and a common cathode Vcom. A capacitor C1 is connected between the gate of the driver TFT Q1 and the voltage line Ui. The switching TFT Q2 is connected between the gate and drain of the driver TFT Q1. A capacitor C3 is connected between the drain of the driver TFT Q1 and a source line Sj.

### TECHNICAL FIELD

The present invention relates to OLED (organic light emitting diode) displays, FEDs (field emission displays), and other display devices which utilize current-driven elements and to their driving methods.

### BACKGROUND ART

We have seen in recent years a lot of research and development activities for current-driven light emitting elements (e.g. OLEDs and FEDs). Among them, the OLED display is attracting especially much attention for its light emitting capability on low voltage and low power consumption with prospective applications in mobile devices such as mobile phones and PDAs (personal digital assistants).

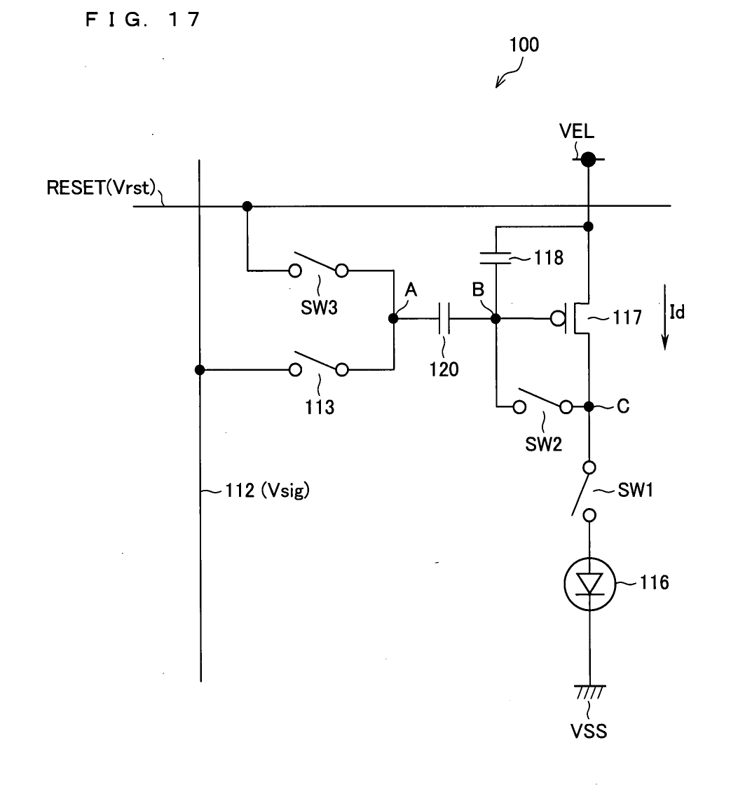

A pixel circuit structure for the OLED display, as disclosed in Japanese Unexamined Patent Publication (Tokukai) 2003-173165 (published Jun. 20, 2003), is shown in FIG. 17. In the following, the gate voltage of a TFT is referenced to its GND potential, whilst the gate-to-source voltage and the threshold voltage Vth are referenced to the source voltage. The source-to-drain voltage is the voltage on the source relative to that on the drain in the p-TFT and the voltage on the drain relative to that on the source voltage in the n-TFT. These definitions will be used throughout this specification.

A pixel circuit 100 shown in FIG. 17 contains a p-type driver TFT (thin film transistor) 117, three switches SW1 to SW3, a pixel switch 113, two capacitors 118, 120, and an OLED 116. Also provided on the panel are a power supply line VEL, a common cathode VSS, a signal line 112, and a reset line RESET. The power supply line VEL applies necessary voltage to the pixel circuit 100. The power supply line VEL delivers a predetermined power supply voltage. The common cathode VSS delivers a predetermined voltage that is lower than the power supply voltage on the power supply line VEL. The signal line 112 delivers a video signal voltage Vsig. The reset line RESET delivers a voltage Vrst.

The driver TFT 117, switch SW1, and OLED 116 are connected in series in this order between the power supply line VEL and the common cathode VSS, from the power supply line VEL toward the common cathode VSS. The OLED 116 is a current-driven electro-optical element which shines with a luminance corresponding to electric current. The capacitor 118 is connected between the gate of the driver TFT 117 and the power supply line VEL. The capacitor 120 and the pixel switch 113 are connected in series in this order between the gate of the driver TFT 117 and the signal line 112, from the gate of the driver TFT 117 to the signal line 112. The switch SW2 is connected between the gate and drain of the driver TFT 117. The switch SW3 is connected between node A where the capacitor 120 is connected to the pixel switch 113 and the reset line RESET.

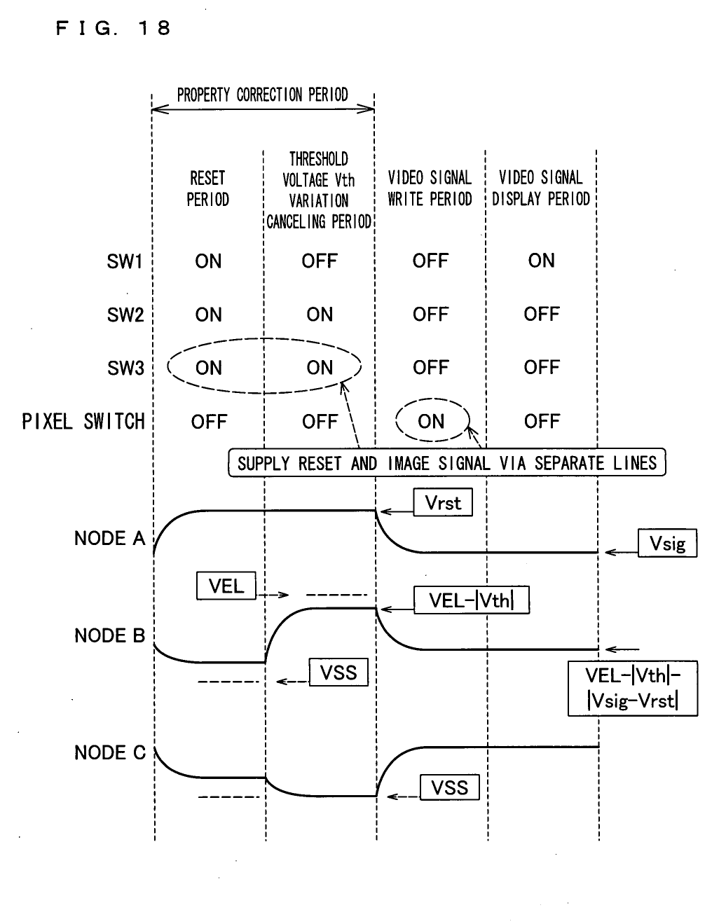

Nodes B and C denote the gate and drain, respectively, of the driver TFT 117. FIG. 18 illustrates the operation of the pixel circuit 100 in relation with voltage changes at nodes A to C and the on/off state of the switches SW1 to SW3 and the pixel switch 113.

As can be seen from FIG. 18, the pixel circuit 100 goes first into a reset period when the switches SW1 to SW3 are closed and the pixel switch 113 is opened. Consequently, the voltage at node A rises to Vrst, and the voltages at nodes B and C approach VSS, the voltage on the common cathode VSS. “VSS” denotes both the common cathode and the voltage on it.

Next, the pixel circuit 100 moves into a threshold voltage Vth variation cancelling period when the switch SW1 is opened, the switches SW2 and SW3 are closed, and the pixel switch 113 is opened. Since the switch SW1 is opened, current flows from the drain to the gate of the driver TFT 117, raising the gate voltage until the gate-to-source voltage of the driver TFT 117 reaches the threshold voltage Vth, turning off the driver TFT 117. As a result, the voltage at node B equals VEL−|Vth|. “VEL” denotes both the power supply line and the voltage on it. Although the notation is in line with the definition above that the threshold voltage Vth is referenced to the source voltage, the absolute value of the threshold voltage Vth is taken because the driver TFT 17 is a p-type and its threshold voltage Vth is generally indicated in negative value.

Then, the pixel circuit 100 enters a video signal write period when the switches SW2 and SW3, as well as the switch SW1, are opened and the pixel switch 113 is closed. This changes the voltage at node A from Vrst to Vsig, which in turn changes the voltage at node B. More specifically, the voltage at node B decreases due to the change of the node A voltage from Vrst to Vsig. Therefore, the gate-to-source voltage of the driver TFT 117 is greater than the threshold voltage Vth by a predetermined value in absolute value.

Subsequently, the pixel circuit 100 goes into a video signal display period when the pixel switch 113 is opened to hold the node B voltage and the switch SW1 is closed to illuminate the OLED 116 with the node B voltage.

The use of the pixel circuit 100 in FIG. 17 in the above manner removes the effect of the variations in the threshold voltage Vth of the driver TFT 117 from the gate voltage of the driver TFT 117.

The current flow through the driver TFT 117 is dictated by the gate-to-source voltage of the driver TFT 117 after threshold correction when the source-to-drain voltage is sufficiently high.

Thus, the current flow from the driver TFT 117 to the OLED 116 can be made independent of the threshold voltage Vth of the driver TFT 117.

The above threshold correction for the driver TFT 117 is done because the threshold voltage Vth of the TFT may vary on the glass substrate. The gate-to-source voltages for drain currents uniformly change, depending on positions on the glass substrate, in the saturation region of a characteristic curve representing the relationship between the drain current and the source-to-drain voltage of the TFT. This property is utilized in dealing with the variations to increase the absolute values of the gate-to-source voltages by the same amount for all the TFTs from a threshold state in which the gate-to-source voltages of the TFTs equal the threshold voltage Vth (a threshold state in which the drain current either starts or stops flowing) so that the drain currents are about equal among the TFTs, independent of the threshold voltage Vth.

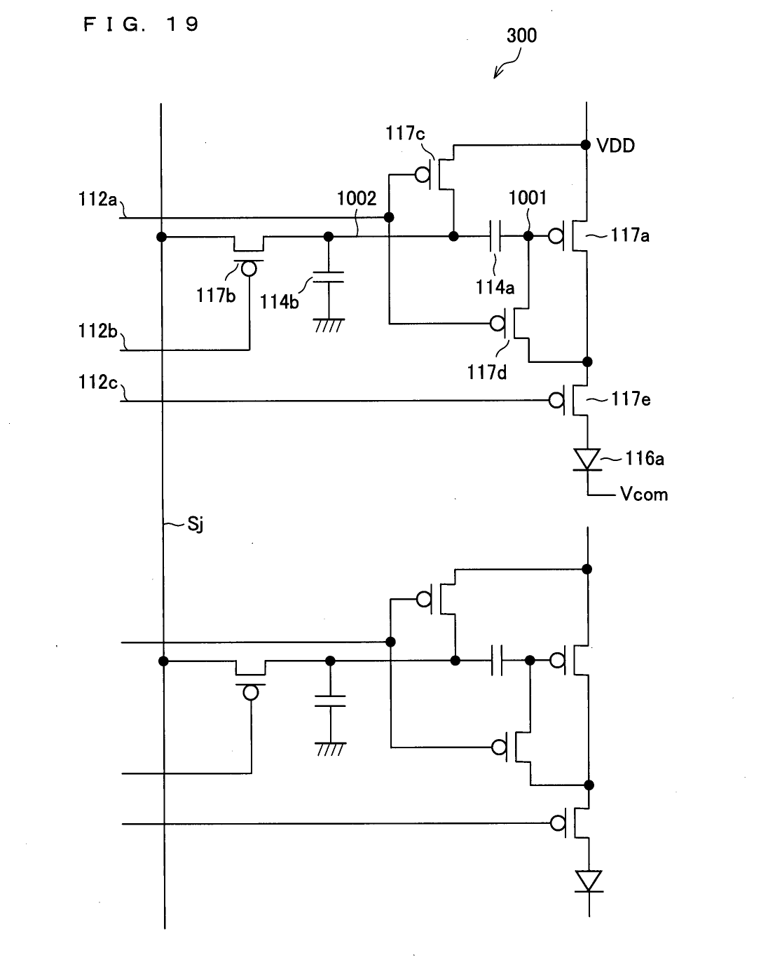

Another pixel circuit structure for the OLED display which implements similar threshold correction is disclosed in Japanese Unexamined Patent Publication (Tokukai) 2003-195809 (published Jul. 9, 2003). The circuit structure is shown in FIG. 19.

A pixel circuit 300 in FIG. 19 contains a p-type driver TFT 117a, four p-type switching TFTs 117b to 117e, two capacitors 114a and 114b, and an OLED 116a. Also provided on the panel are a power supply line VDD, a common cathode Vcom, a source line Sj, and control lines 112a to 112c. The power supply line VDD applies necessary voltage to the pixel circuit 300. The power supply line VDD delivers a predetermined power supply voltage. The common cathode Vcom delivers a predetermined voltage that is lower than the power supply voltage on the power supply line VDD. The source line Sj delivers a data voltage Vda. The control lines 112a to 112c deliver a voltage that is altered between HIGH and LOW.

The driver TFT 117a, switching TFT 117e, and OLED 116a are connected in series in this order between the power supply line VDD and the common cathode Vcom, from the power supply line VDD toward the common cathode Vcom. The switching TFT 117d is connected between the gate (contact 1001) and drain of the driver TFT 117a. The capacitor 114a and the switching TFT 117b are connected in series between the gate of the driver TFT 117a and the source line Sj, from the gate of the driver TFT 117a to the source line Sj. The switching TFT 117c is connected between a contact 1002 where the capacitor 114a is connected to the switching TFT 117b and the source of the driver TFT 117a. The capacitor 114b is connected between the contact 1002 and the GND wire.

The gates of the switching TFTs 117c and 117d are connected to the control line 112a. The gate of the switching TFT 117b is connected to the control line 112b. The gate of the switching TFT 117e is connected to the control line 112c.

The pixel circuit 300 operates as follows. First, the control line 112a is LOW, turning on the switching TFTs 117c and 117d, which in turn applies the power supply voltage VDD to the contact 1002 and short-circuits the gate and drain of the driver TFT 117a. “VDD” denotes both the power supply line and the voltage on it. Then, the control line 112c is turned LOW, turning on the switching TFT 117e, which in turn brings the contact 1001 voltage to approach Vcom and turns on the driver TFT 117a. “Vcom” denotes both the common cathode and the voltage on it.

Next, the control line 112c is turned HIGH, turning off the switching TFT 117e. Consequently, the voltage at the contact 1001 rises, which pushes the driver TFT 117a into and beyond a threshold state, turning off the driver TFT 117a. As a result, the voltage at the contact 1001 equals VDD−|Vth|. Again, the absolute value of the threshold voltage Vth is taken for its magnitude. The capacitor 114a thus holds |Vth| with the contact 1001 side being negative relative to the opposite side, that is, the source of the TFT 117a.

Thereafter, the control line 112a is turned HIGH, turning off the switching TFTs 117c and 117d. The control line 112b is turned LOW, turning on the switching TFT 117b. Consequently, the voltage at the contact 1002 changes from the power supply voltage VDD to the data voltage Vda on the source line Sj. The voltage at the contact 1001 therefore changes from VDD−|Vth| to the data voltage Vda−|Vth|.

Thereafter, the control line 112b is turned HIGH, turning off the switching TFT 117b. The control line 112c is turned LOW, turning on the switching TFT 117e. As a result, the gate voltage of the driver TFT 117a is held at Vda−|Vth|, and the gate-to-source voltage of the driver TFT 117a equals Vda−|Vth|−VDD.

The current flow from the driver TFT 117a to the OLED 116a can be regulated in the above manner independently of the threshold voltage Vth of the driver TFT 117a. The current level is dictated by how the relationship between Vda and VDD is designed.

The use of the pixel circuit 300 in FIG. 19 in the above manner regulates the current flow from the driver TFT 117a to the OLED 116a, independently of the threshold voltage Vth of the driver TFT 117a.

### DISCLOSURE OF INVENTION

The use of the pixel circuit in FIG. 17 or FIG. 19 as above allows a desired current to be fed to the OLED independently of the threshold voltage Vth of the driver TFT.

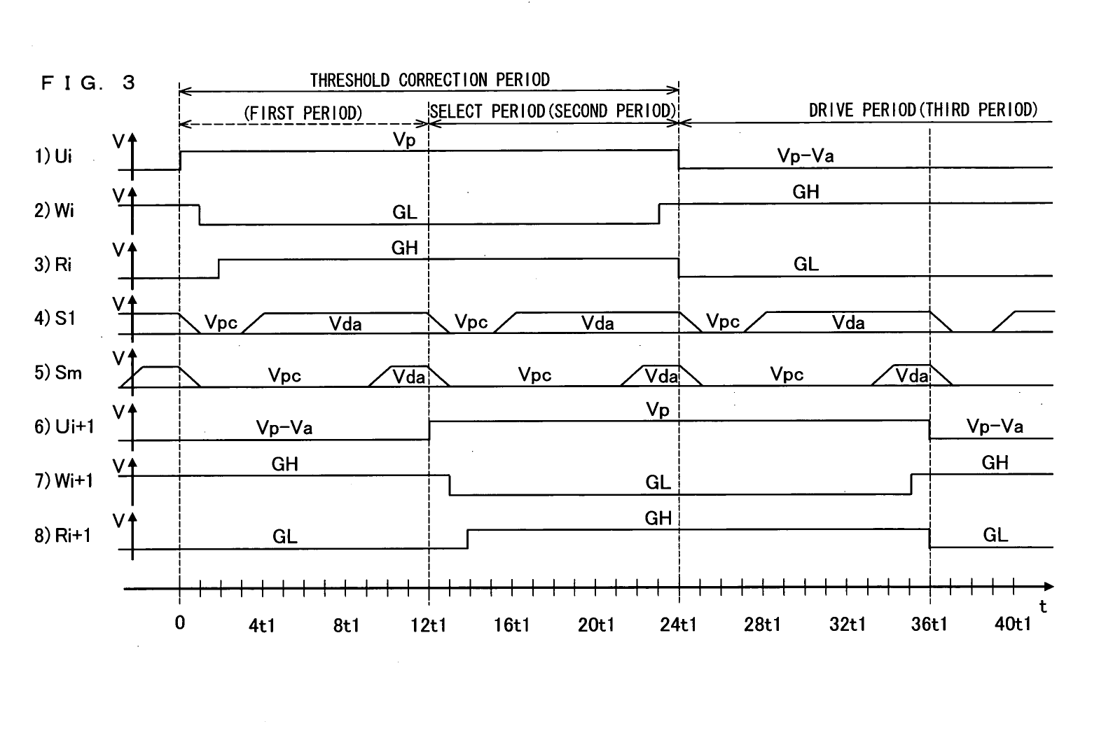

However, the pixel circuit 100 in FIG. 17 requires five TFTs and two capacitors because the switches SW1 to SW3 and the pixel switch 113 are all TFTs. This is also true with the pixel circuit 300 in FIG. 3.

Meanwhile, the display on mobile devices are boasting increasingly high resolution. For example, the 2.4-inch QVGA LCD is a popular choice for mobile phones. A pixel on the 2.4-inch QVGA panel measures about 51 μm×RGB×153 μm. Considering this 51 μm×153 μm pixel size for each of the RGB colors and the pixel circuit in FIG. 17 or FIG. 19, it is difficult squeeze in the OLED.

Therefore, little area can be allotted to the OLED in a bottom emission structure, in which light from the OLED is taken out from the side on which the TFT substrate is provided. (The area allotted to the OLED will be called the aperture ratio as is the case with the LCD.) The brightness of a panel is dictated by the average luminance L of the pixels. Meanwhile, the ratio of the area the OLED occupies in a pixel is dictated by the aperture ratio A. The average luminance L of the pixel, the aperture ratio A, and the average luminance LA of the OLED satisfy the equation, L=LA×A. The equation tells that the smaller the aperture ratio A, the greater the average luminance LA of the OLED must be.

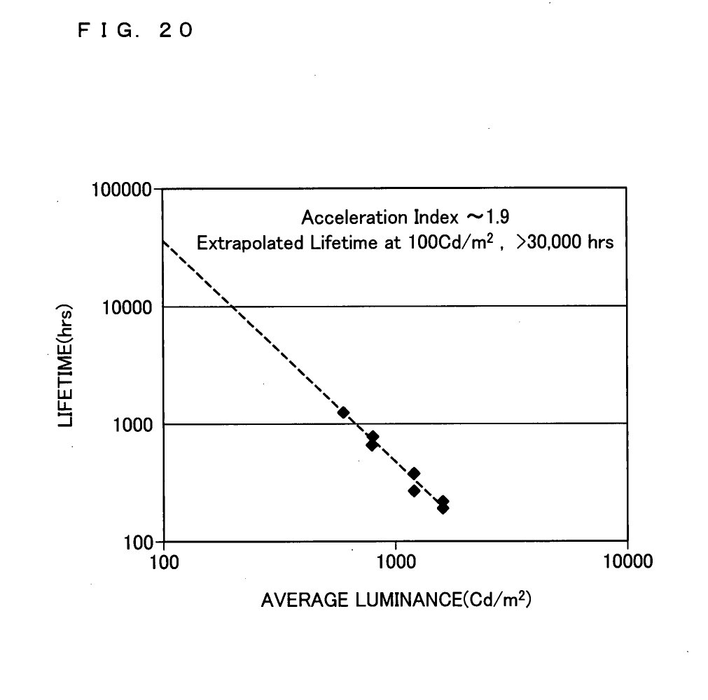

The relationship between the average luminance LA of an OLED and its lifetime is documented, for example, in SID '04 DIGEST, pp. 162-163, which is reproduced in FIG. 20.

According to FIG. 20, the luminance half-life T50 of the OLED is given by Eq. 1:

T50∝1/(LA)^{1.9}=1/(L/A)^{1.9} Eq. 1

A smaller aperture ratio A leads to an extremely shorter lifetime.

Lifetime is thought to be a major key factor to commercialization of the OLED. Using the pixel circuit in FIGS. 17 and 19, a desired current can be delivered to the OLED independently of the threshold voltage Vth of the driver TFTs 117, 117a. However, each pixel needs five TFTs and two capacitors. Therefore, in the bottom emission structure, in which light from the OLED is taken out from the side on which the TFT substrate is provided, the aperture ratio A is small. That necessitates an increased OLED average luminance LA, which in turn leads to problematic, short OLED lifetime.

In a top emission structure, in which light from the OLED is taken out from the side on which the TFT substrate is not provided, the aperture ratio A is determined independently of the number of elements per pixel. However, even if the pixel circuit in FIG. 17 or 19 is used, the circuit still contains so many elements (five TFTs and two capacitors). Those elements occupy a large footprint and are difficult to squeeze in the pixel, making it difficult to improve on the resolution of the 2.4-inch QVGA.

The present invention, conceived in view of these problems, has objectives of providing a display device and related driving method which provides for such a circuit structure that it delivers a desired current to the electro-optical element independently of the threshold voltage of the driver transistor and contains a reduced number of elements per pixel.

A display device of the present invention, to address the problems, is characterized as follows. It includes pixels arranged in a matrix. Each pixel includes a current-driven electro-optical element and a driver transistor. The driver transistor outputs a current (drive current) from its current output terminal to the electro-optical element. The driver transistor controls its current output based on the voltage on its current control terminal referenced to a reference voltage terminal connected to a power supply line. The display device includes first voltage lines for output of a first voltage and data lines for output of a data voltage representative of display data for the pixels. Each pixel includes: a first capacitor connected between the current control terminal and a first voltage line; a first switching element connected between the current control terminal and the current output terminal; and a second capacitor connected between the current output terminal and a data line.

According to the invention, first, a first period is provided in which: the first voltage on the first voltage line is set to a predetermined voltage; the voltage on the data line is set to a reset voltage and then to a data voltage with the first switching element being closed; and the voltage on the current control terminal of the driver transistor is set to a voltage at which the driver transistor is in threshold state in which its output current either starts or stops flowing. Then, following the first period, a second period is provided in which the voltage on the data line is set to the reset voltage and then to the data voltage; and the first switching element is opened. At this timing, the voltage on the current control terminal of the driver transistor is changeable through the voltage on the data line using the first capacitor and the second capacitor. Therefore, the voltage on the current control terminal can be distanced from the voltage on the current control terminal when in threshold state by a value that is in accordance with the data voltage. Following the second period, a third period is provided in which the voltage on the first voltage line is changed to control the voltage on the current control terminal and drive the electro-optical element. The third period enables supplying a drive current from the driver transistor to the electro-optical element in accordance with the data voltage, independently of the threshold voltage.

Therefore, the display device, capable of supplying a drive current to the electro-optical element in accordance with the data voltage without being affected by variations in the threshold voltage of the driver transistor, can be built from one driver transistor, one to no more than three switching elements, and two capacitors, even if there is a switching element provided between the current output terminal of the driver transistor and the electro-optical element or the data line.

When the driver transistor and the switching element(s) are TFTs, the display device can be built from two to no more than four TFTs and two capacitors. The display device contains a reduced number of elements per pixel when compared to conventional art. The display device, when applied to a bottom emission structure, increases the aperture ratio, allowing for extending the lifetime of the OLED. In addition, when applied to a top emission structure, the display device allows for increased resolution.

Another display device of the present invention, to address the problems, is characterized as follows. It provides a first period, a second period, and a third period. In the first period: the first voltage on the first voltage line is set to a predetermined voltage; the voltage on the data line is set to a reset voltage and then to a data voltage with the first switching element being closed; and the voltage on the current control terminal of the driver transistor is set to a voltage at which the driver transistor is in threshold state in which its output current either starts or stops flowing. In the second period which follows the first period, the voltage on the data line is set to the reset voltage and then to the data voltage. In the third period which follows the second period, the voltage on the current control terminal is controlled to drive the electro-optical element.

According to the invention, the number of elements per pixel is reduced. Yet, a desired current can be delivered to the electro-optical element independently of the threshold voltage of the driver transistor.

Another display device of the present invention, to address the problems, is characterized as follows. The first switching element is opened in the second period while the voltage on the data line is being equal to the data voltage, so as to enter the third period. The first voltage on the first voltage line is changed from the predetermined voltage in the third period, so as to control the voltage on the current control terminal.

According to the invention, the voltage on the current control terminal of the driver transistor in accordance with the data voltage fed to the data line in the second period can be changed to a desired voltage by changing the first voltage on the first voltage line in the third period using the first capacitor. Therefore, the drive control voltage is readily set up to a desired level.

Either of the following two arrangements provides the means of achieving the threshold state in the first period where the output current of the driver transistor either starts or stops flowing.

The first arrangement is characterized in that the current output terminal of the driver transistor and the electro-optical element are connected via a second switching element.

According to the arrangement, a current is generated flowing from the driver transistor to the electro-optical element by closing the second switching element. A current is stopped from flowing from the driver transistor to the electro-optical element by opening the second switching element.

The second arrangement is characterized in that: the current output terminal of the driver transistor is connected to one of two terminals of the electro-optical element; and the other terminal of the electro-optical element is connected to a second voltage line which outputs a second voltage.

According to the arrangement, the voltage across the electro-optical element can be set to such a level at which a current flows occurs through the electro-optical element and also to such a level at which no current flows through the electro-optical element. Therefore, only one switching element is necessary: namely, the first switching element. A display device can be built which contains fewer elements.

Preferably, a third switching element is connected parallel to the second capacitor so as to turn on the driver transistor at the onset of the first period.

According to the arrangement, the voltage on the current control terminal of the driver transistor can be set to the voltage on the data line by turning on the third switching element. Therefore, the voltage on the current control terminal of the driver transistor is controlled through the data line.

A method of driving a display device of the present invention, to address the problems, is characterized as follows. It is a method of driving the foregoing display device and provides a first period, a second period, and a third period. In the first period: the voltage on the current control terminal of the driver transistor is set to such a voltage that a threshold state is achieved in which the output current of the driver transistor either starts or stops flowing, while maintaining the first voltage on the first voltage line at a predetermined voltage and the first switching element closed. In the second period, which follows the first period, the voltage on the data line is set to the reset voltage and then to the data voltage. In the third period, which follows the second period, the voltage on the data line is set to the data voltage, and the voltage on the current control terminal is controlled to drive the electro-optical element.

According to the invention, the display device can be driven so that it can supply a drive current to the electro-optical element in accordance with the data voltage without being affected by variations in the threshold voltage of the driver transistor.

A more preferable method of driving a display device of the present invention, to address the problems, is characterized as follows. The first switching element is opened in the second period while the voltage on the data line is being equal to the data voltage, so as to enter the third period. The voltage on the first voltage line is changed from the voltage on the power supply line in the third period, so as to control the voltage on the current control terminal.

According to the invention, the voltage on the current control terminal of the driver transistor in accordance with the data voltage fed to the data line in the second period can be changed to a desired voltage by changing the first voltage on the first voltage line in the third period using the first capacitor. Therefore, the drive control voltage is readily set up to a desired level.

A more preferable display device of the present invention is such that a fourth switching element is connected in series with the second capacitor. The second capacitor may be provided on either the current output terminal side or the data line side of the driver transistor.

According to the invention, the fourth switching element can be turned off in the first period while the voltage on the data line is being equal to the data voltage.

The arrangement restrains the phenomenon in which the voltage on the current control terminal of the driver transistor changes due to the data voltage destined for another pixel which is fed to a data line in the first period. Variations in the output of the driver transistor are restricted.

A more preferable display device of the present invention is such that the fourth switching element is opened in the first period while the voltage on the data line is being equal to the data voltage.

The invention restrains the phenomenon in which the voltage on the current control terminal of the driver transistor changes due to the data voltage destined for another pixel which is fed to a data line in the first period. Variations in the output of the driver transistor are restricted.

The fourth switching element should be closed in the second period while the voltage on the data line is being equal to the data voltage.

Another display device of the present invention may include current-driven electro-optical elements and driver transistors in individual pixels which are arranged in a matrix, each driver transistor supplying an output current from a current output terminal to an electro-optical element as a drive current, the output current being controlled by a voltage on a current control terminal referenced to a reference voltage terminal connected to a power supply line, the device including first voltage lines for outputting first voltages and data lines for outputting data voltages corresponding to display data for the pixels, each pixel including: a first capacitor connected between the current control terminal of an associated one of the driver transistors and an associated one of the first voltage lines; a first switching element connected between the current control terminal of that driver transistor and the current output terminal; and a second capacitor and a fourth switching element connected in series between the current control terminal of the driver transistor and an associated one of the data lines. The second capacitor may be provided on either the current output terminal side or the data line side of the driver transistor.

The display device may provide a first period, a second period, and a third period. In the first period: the voltage on the data line is set to the reset voltage while maintaining the first voltage on the first voltage line at a predetermined voltage and the first and fourth switching elements closed; the voltage on the current control terminal of the driver transistor is set to such a voltage that a threshold state is achieved in which the output current of the driver transistor either starts or stops flowing. In the second period, which follows the first period, the voltage on the data line is set to a reset voltage, the first switching element is opened, the voltage on the data line is set to the data voltage, and then the fourth switching element is opened. In the third period, which follows the second period, the voltage on the first voltage line is changed from the voltage on the power supply line, and the voltage on the current control terminal is controlled so that the electro-optical element emits light.

According to these two display devices of the present invention, the reset voltage and a data voltage for another pixel are applied to the data line while the first switching element is being closed to connect the current control terminal of the driver transistor and the current output terminal. Then, the reset voltage is set to a value not higher than (or not lower than) the data voltage so that the voltage on the current control terminal of the driver transistor can be set to a threshold voltage while the reset voltage is being applied to the data line. In addition, the voltage on the current control terminal of the driver transistor is controlled to equal an OFF voltage while the data line is being applied to the data voltage.

This ensures that the voltage on the current control terminal of the driver transistor is set to the threshold voltage without applying a predetermined voltage to the data line side terminal of the second capacitor from another line when the data line side terminal of the second capacitor changes to the reset voltage.

Thereafter, if the data line side terminal of the second capacitor is set to the data voltage corresponding to that pixel, and the second capacitor is disconnected from the data line, the voltage on the current control terminal of the driver transistor can be changed from the threshold voltage.

In that situation, since the voltage on the current control terminal of the driver transistor is changed to the OFF voltage, the voltage on the current control terminal of the driver transistor can be thereafter set to a given voltage by changing the voltage on the first voltage line.

A more preferable display device of the present invention is such that the reset voltage for the data line is either not lower than the data voltage at any time or not higher than the data voltage at any time as detailed above.

According to the invention, for example, if the driver transistor is a p-type, its reset voltage is set so that it does not exceed the data voltage at any time. This is to set the voltage on the current control terminal of the driver transistor to a value higher than Va while the data voltage is being applied to the data line if the voltage on the current control terminal of the driver transistor changes to Va while the reset voltage is being applied to the data line.

Thus, the period in which the reset voltage is being applied to the data line is the threshold correction period. Since the voltage on the current control terminal of the driver transistor is higher while the data voltage is being applied to the data line than in the threshold correction period, the threshold correction operation is stopped.

If the driver transistor is an n-type, its reset voltage is set to more than or equal to the data voltage at any time, similar operation is possible.

Thus, the driver transistor is capable of supplying a drive current to the electro-optical element in accordance with the data voltage, independently of the threshold voltage.

The switching element which should be connected between the data line side terminal of the second capacitor and another line can be omitted. The number of elements per pixel is reduced over conventional art. A display device can be built which, when applied to a bottom emission structure, increases the aperture ratio, allowing for extending the lifetime of the OLED. In addition, when applied to a top emission structure, the display device allows for increased resolution.

The display device of the present invention, as described in the foregoing, includes first voltage lines for outputting a first voltage and data lines for outputting data voltages corresponding to display data for pixels. Each pixel includes a first capacitor connected between the current control terminal of the driver transistor and the first voltage line, a first switching element connected between the current control terminal of the driver transistor and the current output terminal, and a second capacitor connected between the current output terminal of the driver transistor and the data line.

The display device of the present invention, as described in the foregoing, may include first voltage lines for outputting a first voltage and data lines for outputting data voltages corresponding to display data for pixels. Each pixel may include a first capacitor connected between the current control terminal of the driver transistor and the first voltage line, a first switching element connected between the current control terminal of the driver transistor and the current output terminal, and a second capacitor and a fourth switching element connected in series between the current control terminal of the driver transistor and the data line.

Hence, a display device is provided which feeds a desired current to the electro-optical element independently of the threshold voltage of the driver transistor and which allows for a circuit structure with which the number of elements per pixel is reduced.

Therefore, the display device includes a reduced number of elements per pixel over conventional art, has an increased aperture ratio when applied to a bottom emission structure, and allows for extending the lifetime of the OLED. When applied to a top emission structure, the display device allows for an increased resolution.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

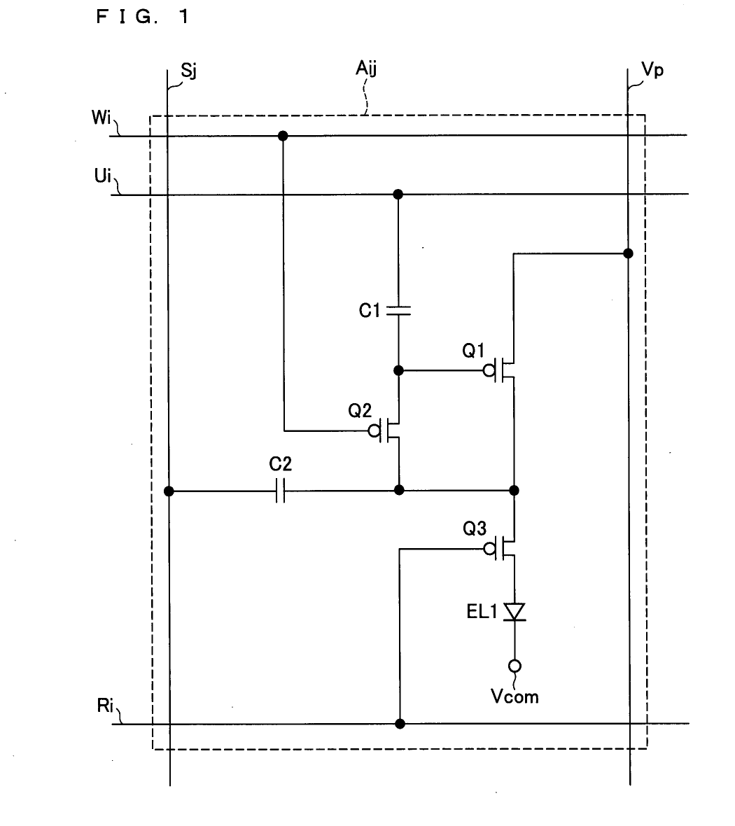

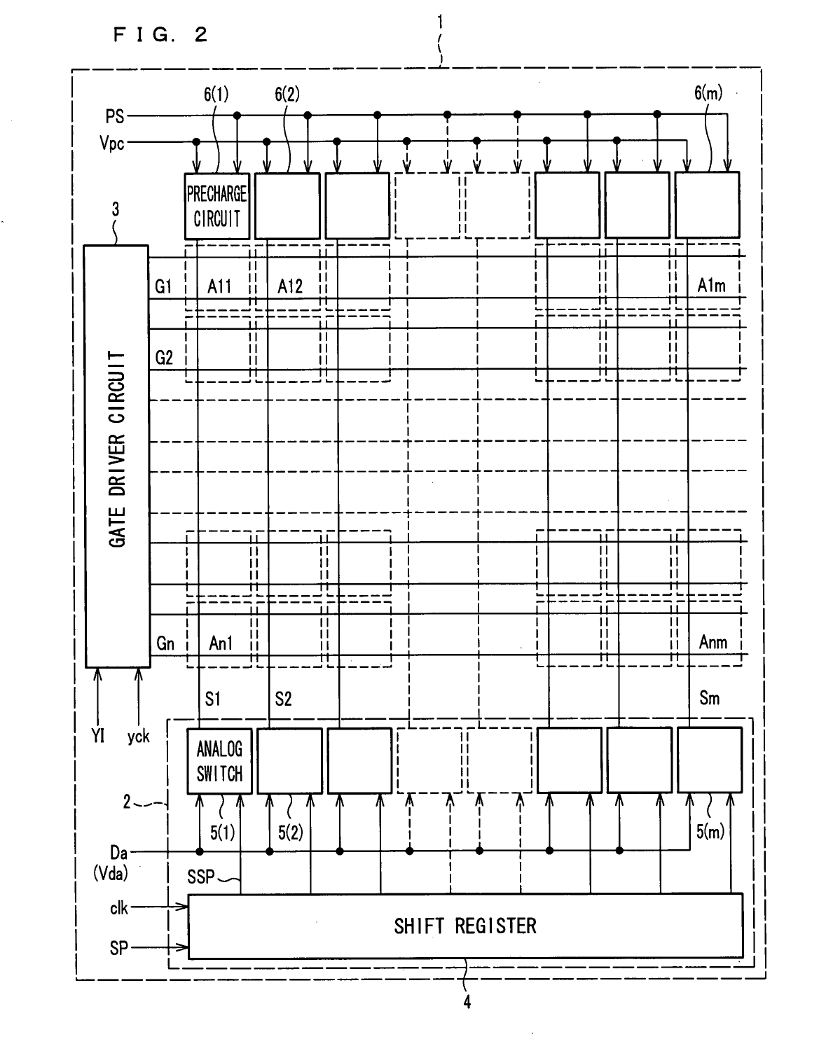

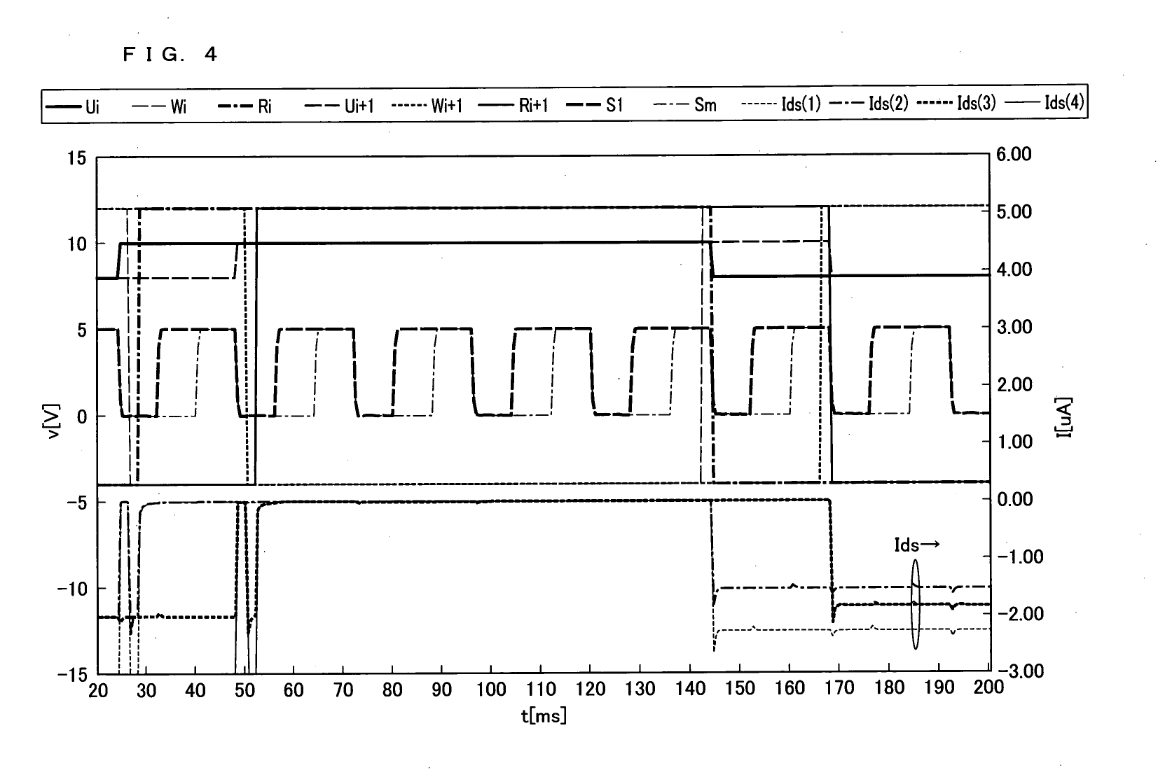

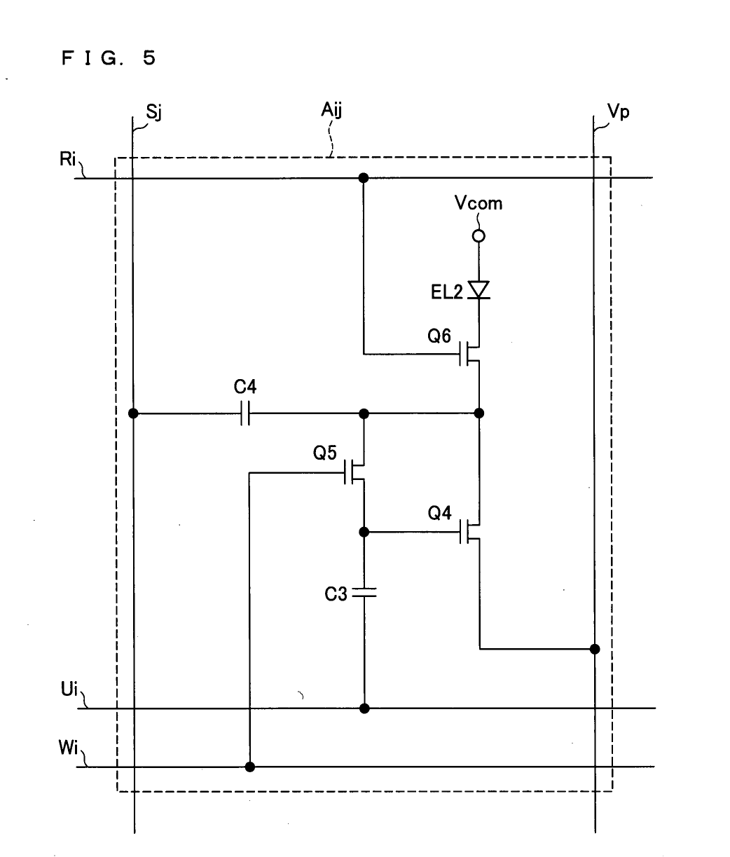

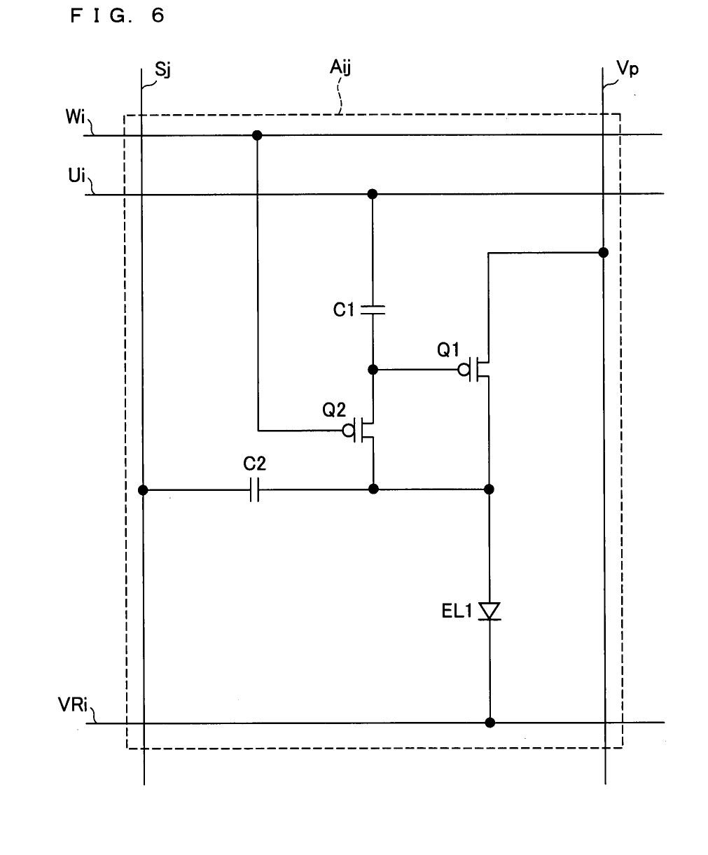

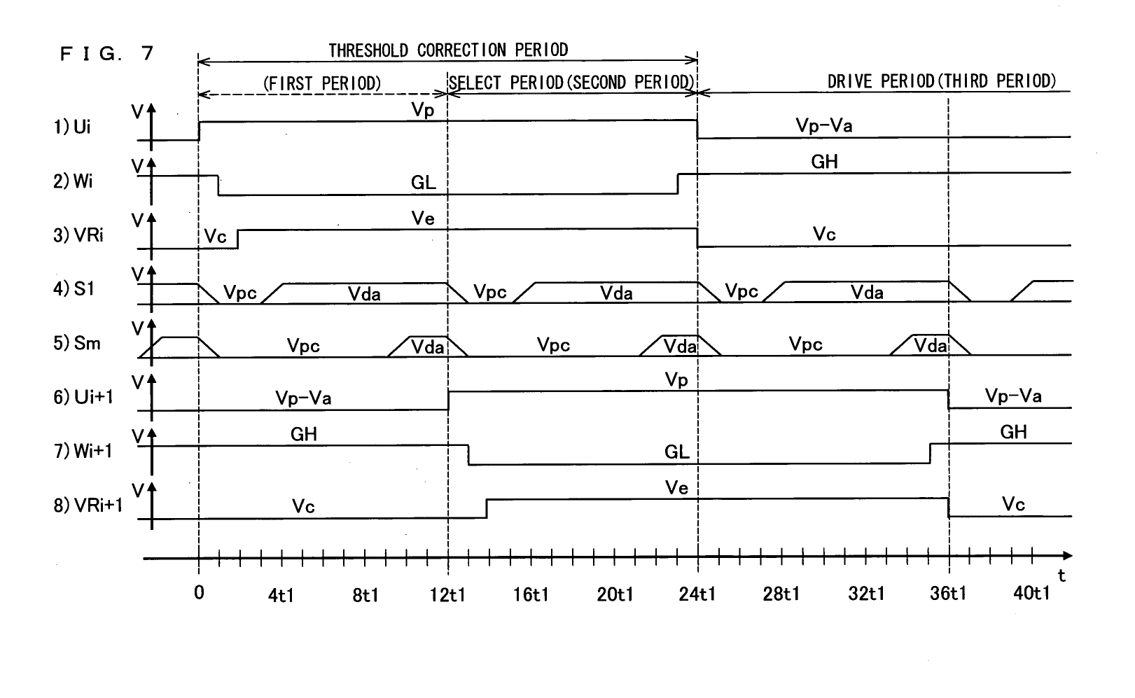

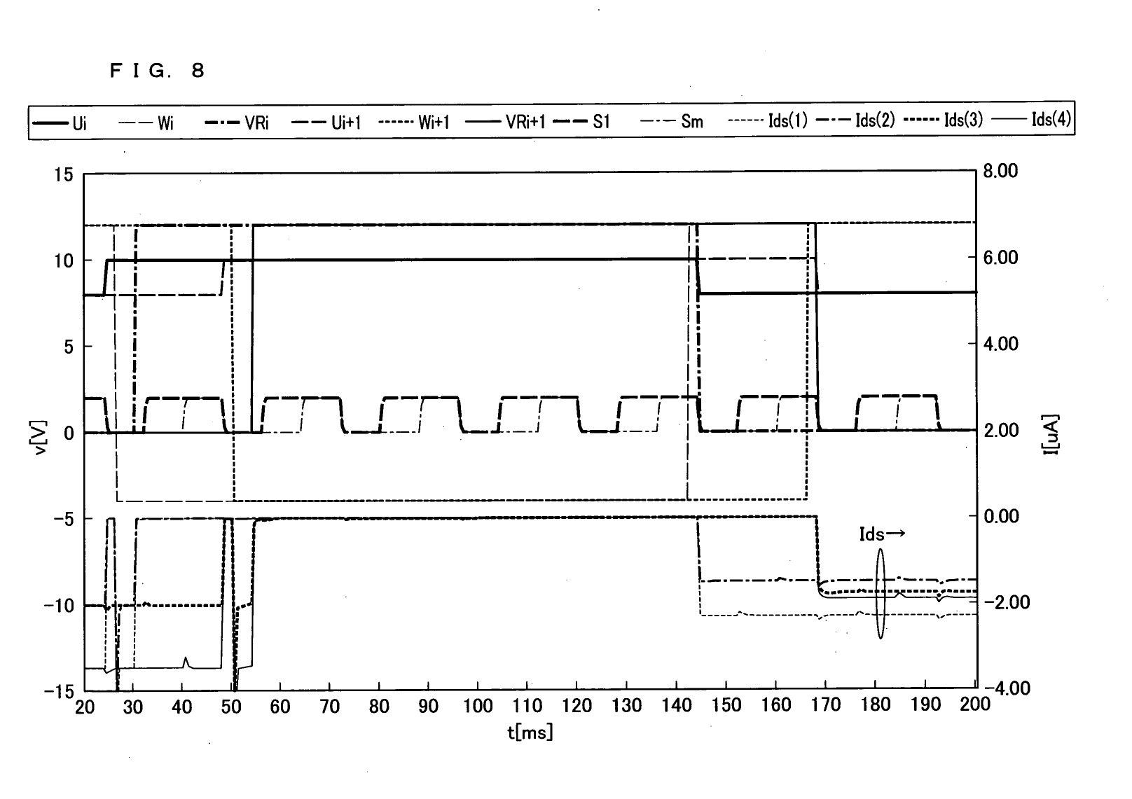

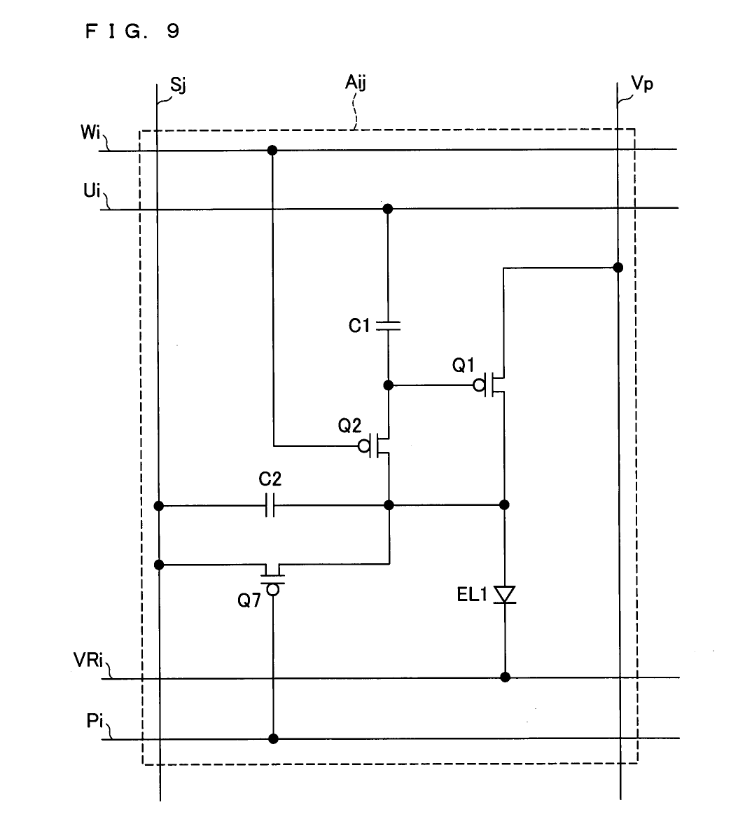

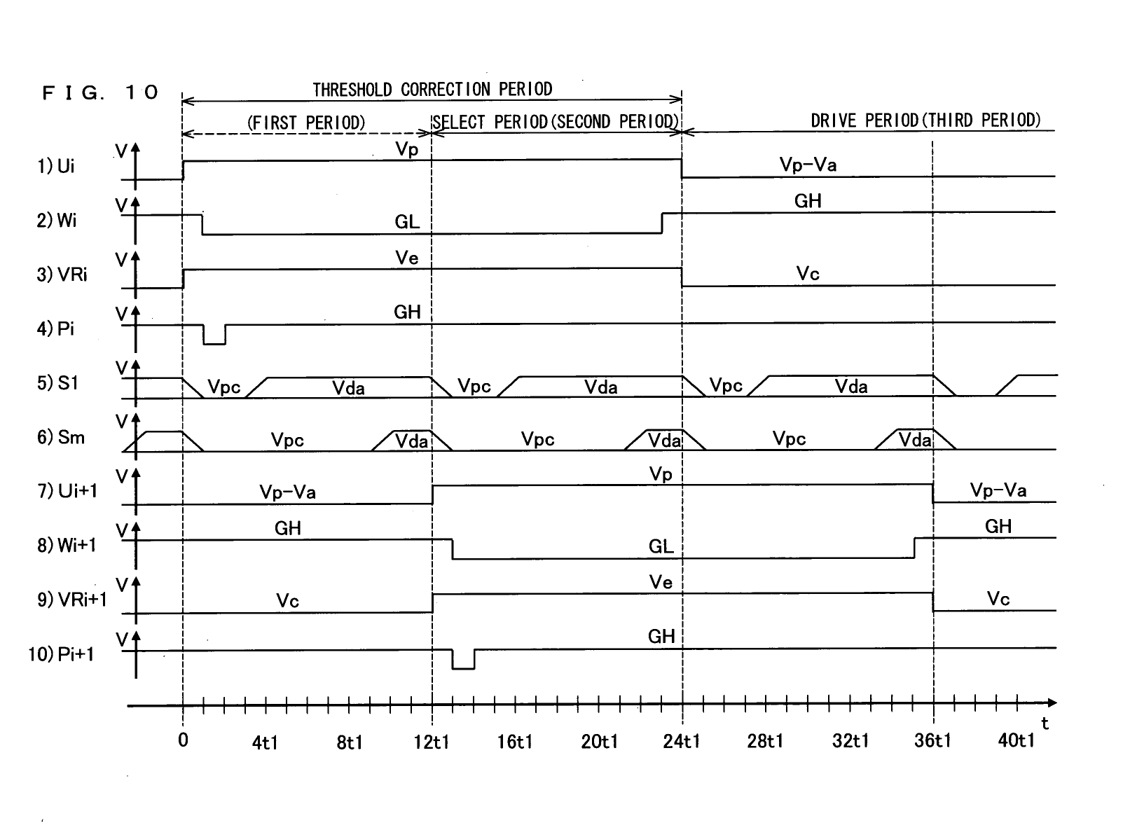

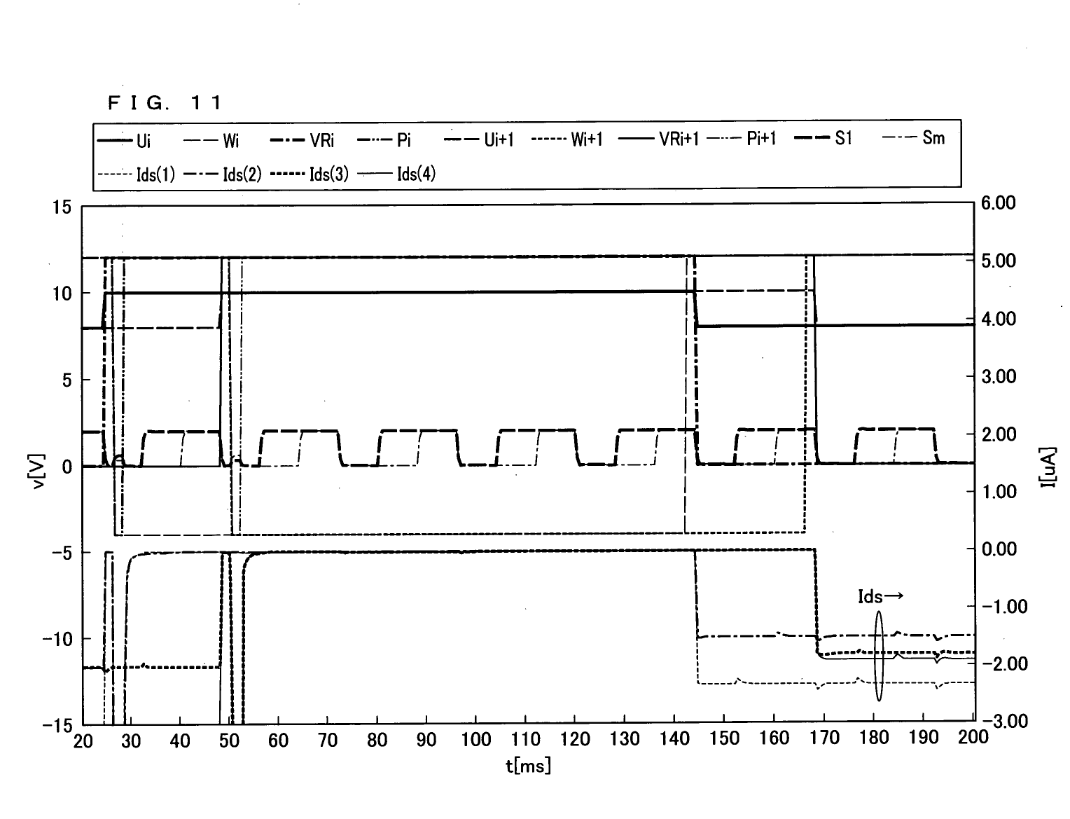

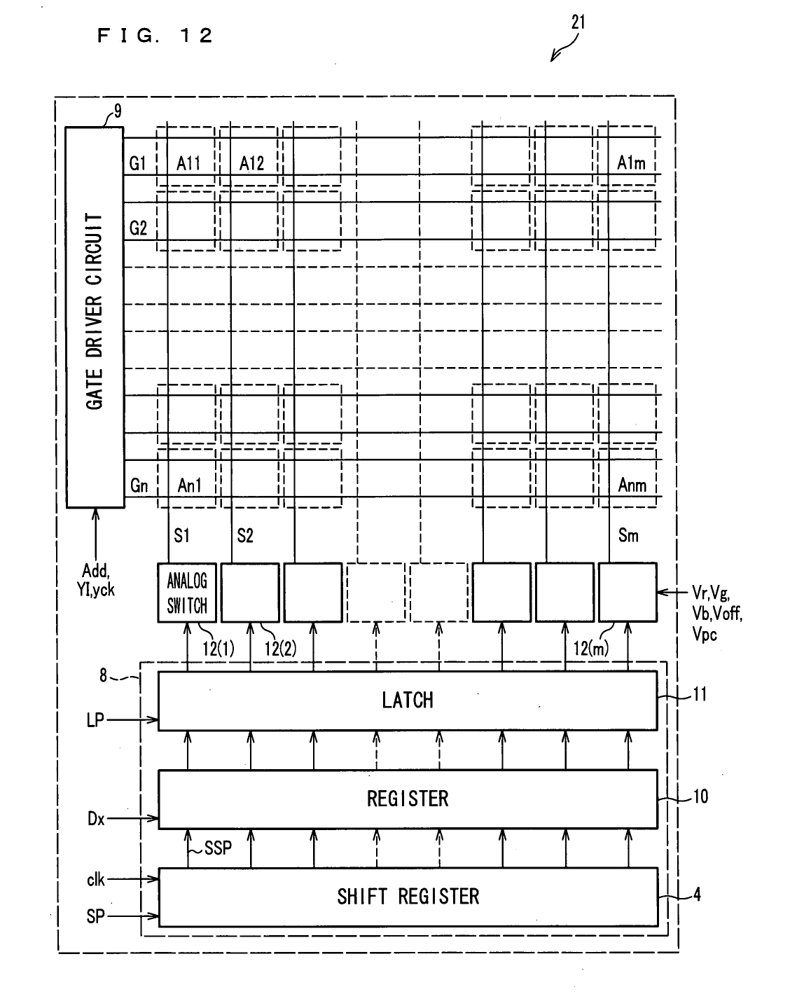

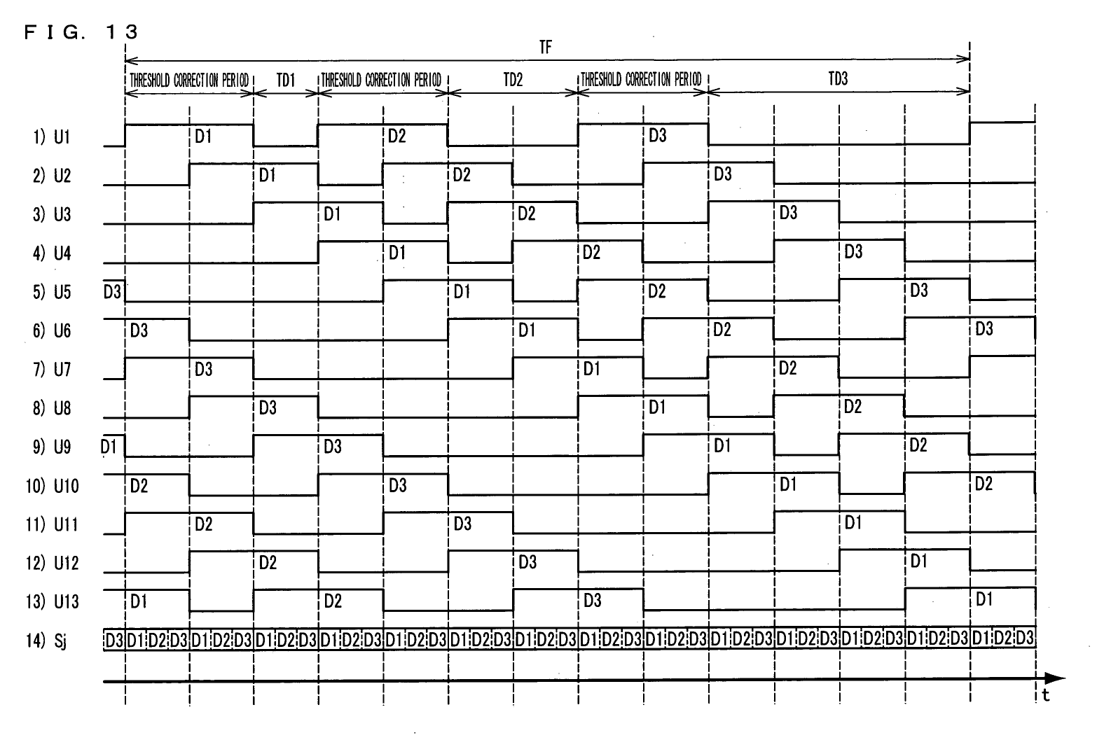

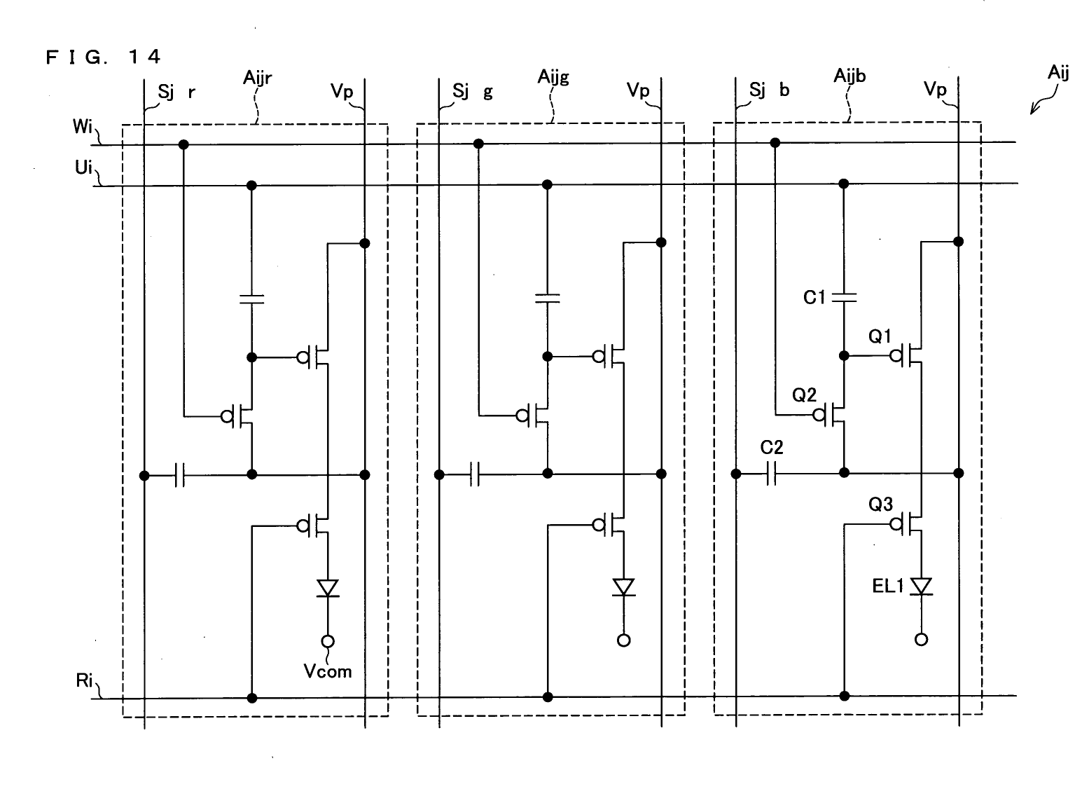

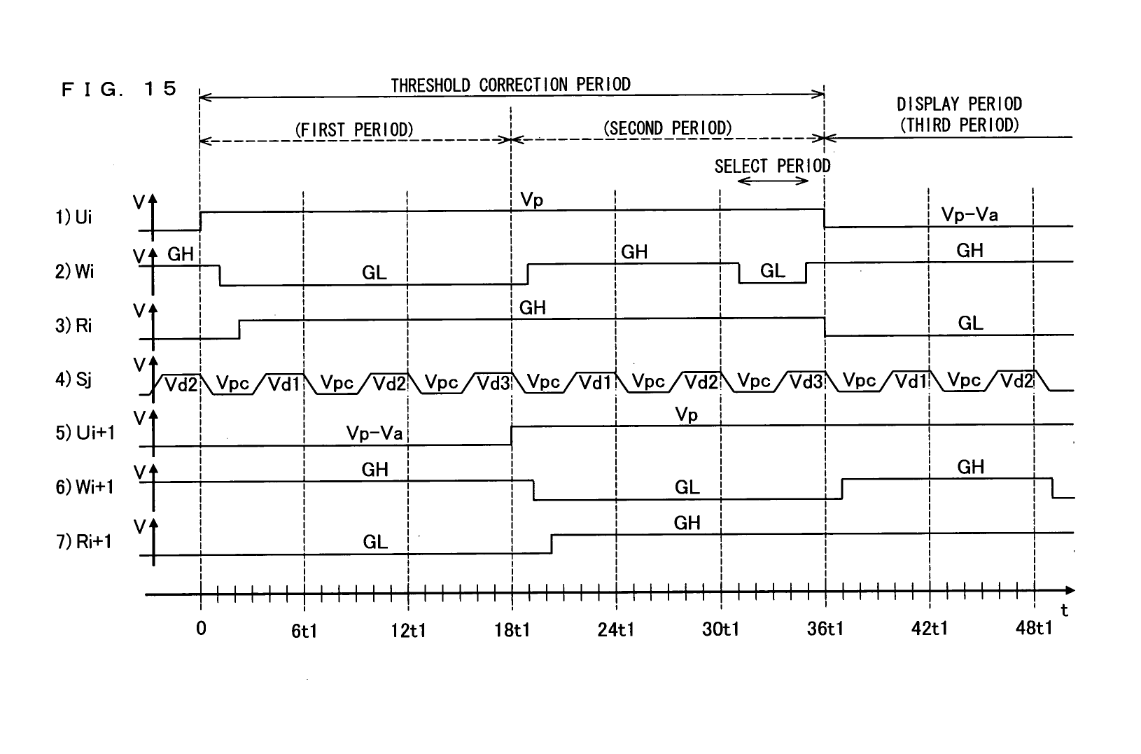

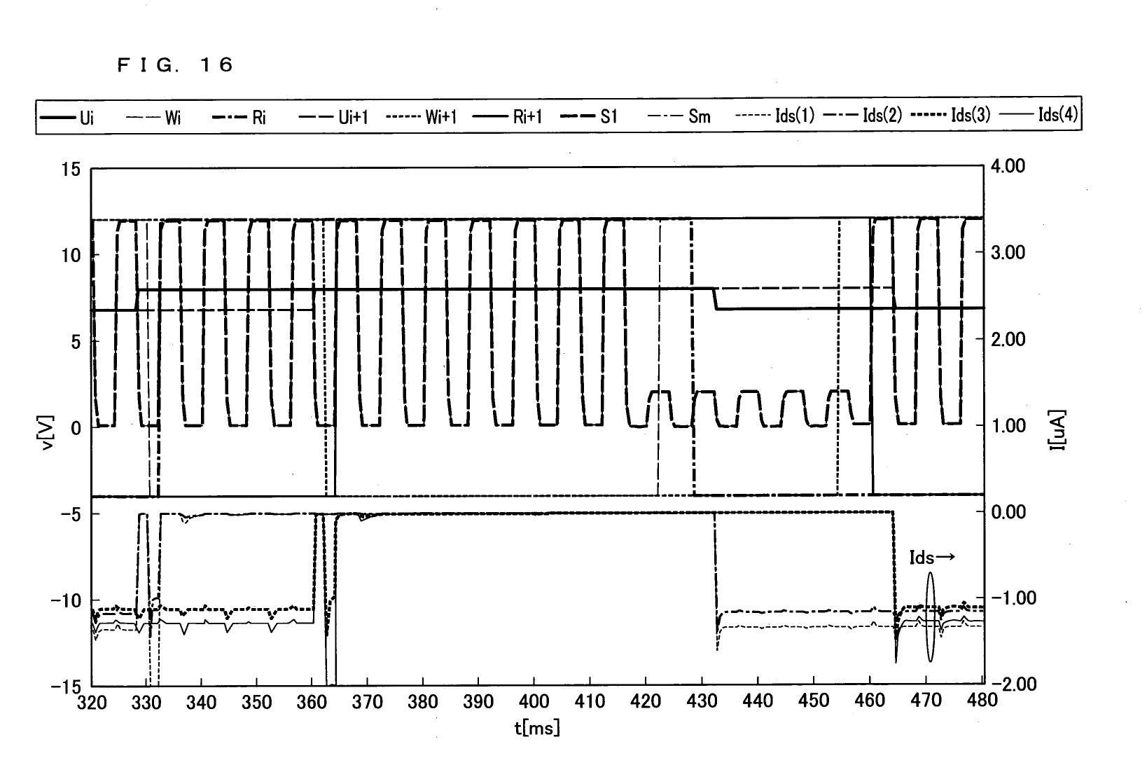

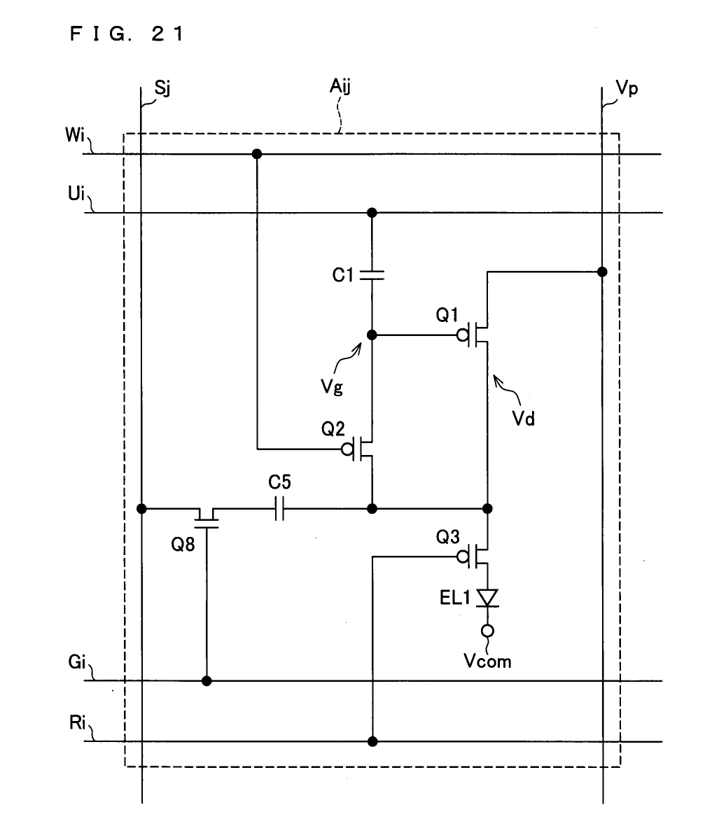

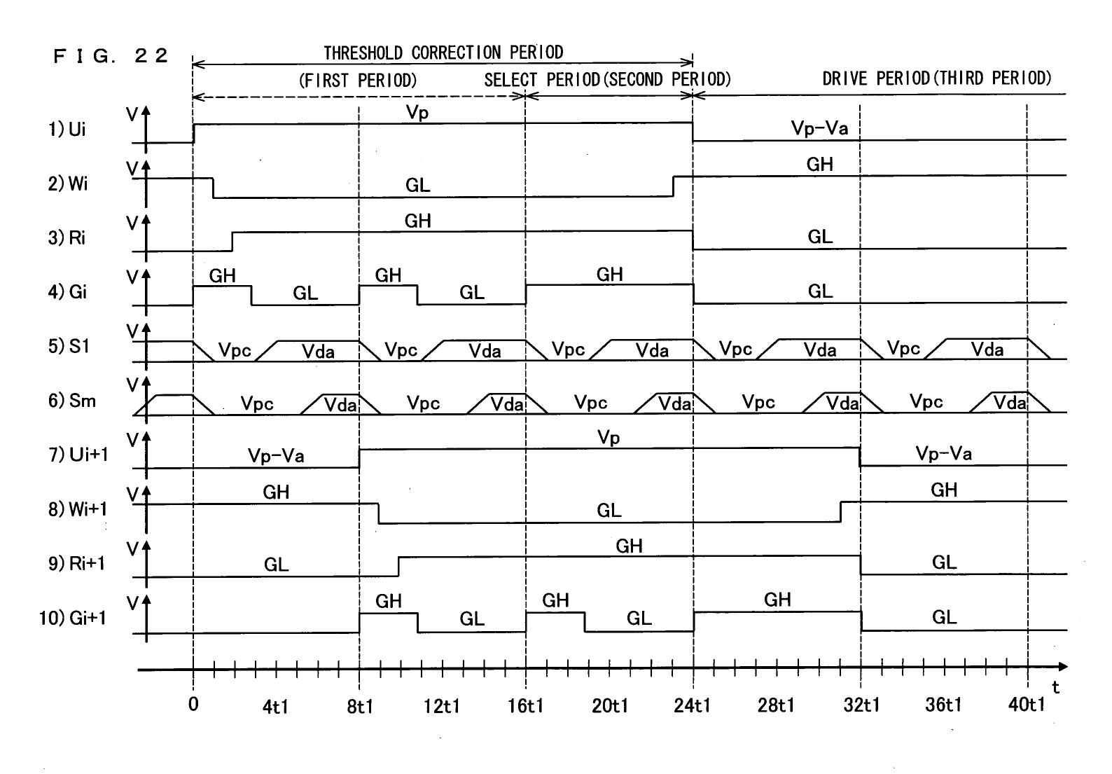

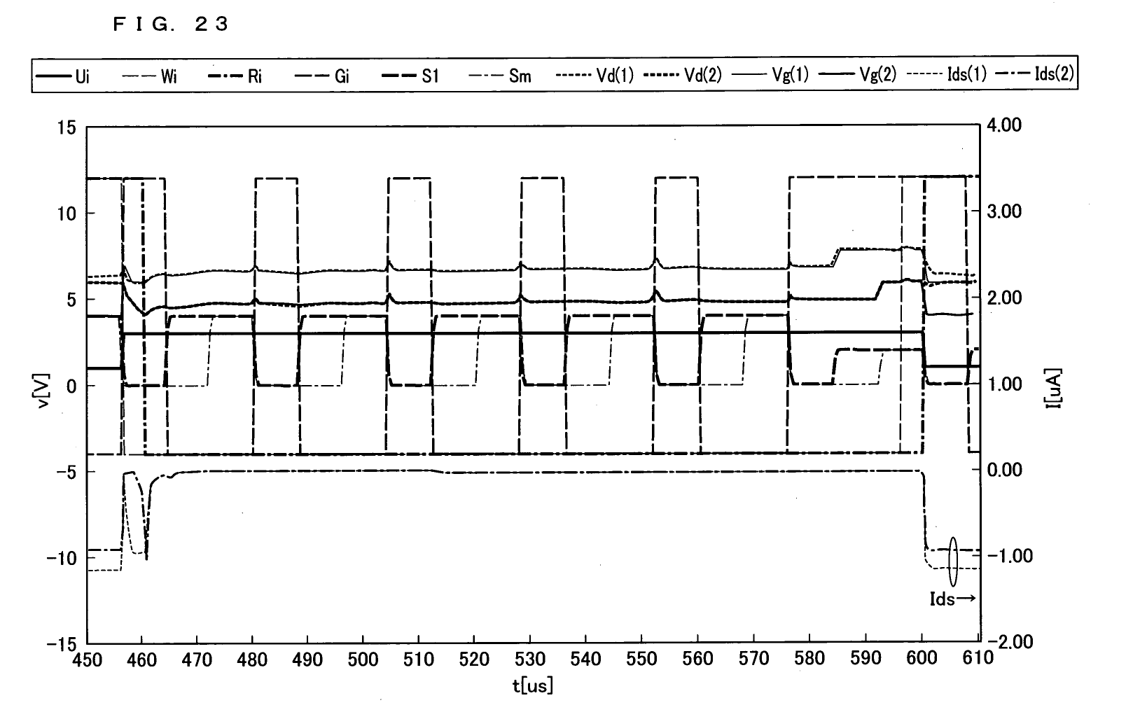

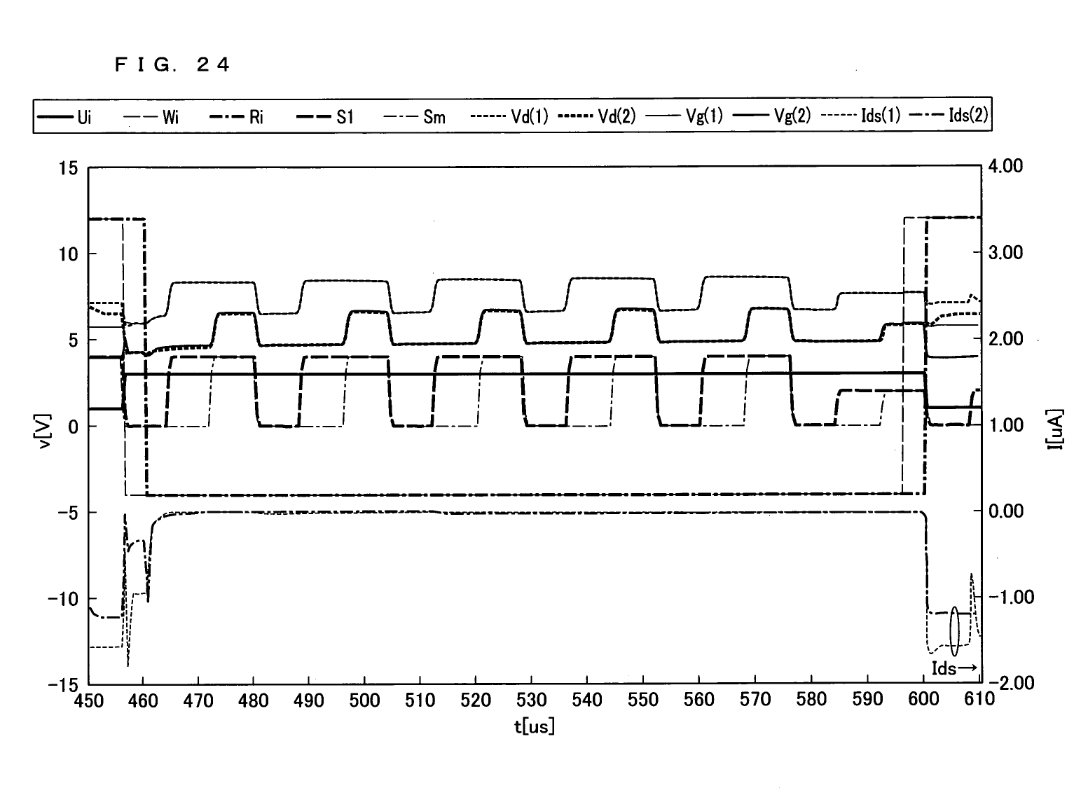

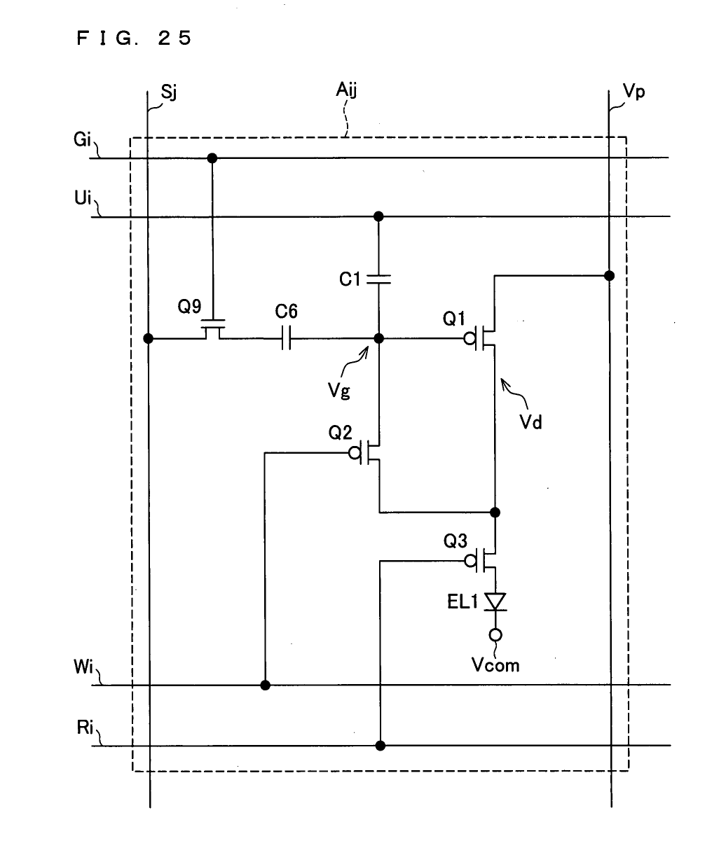

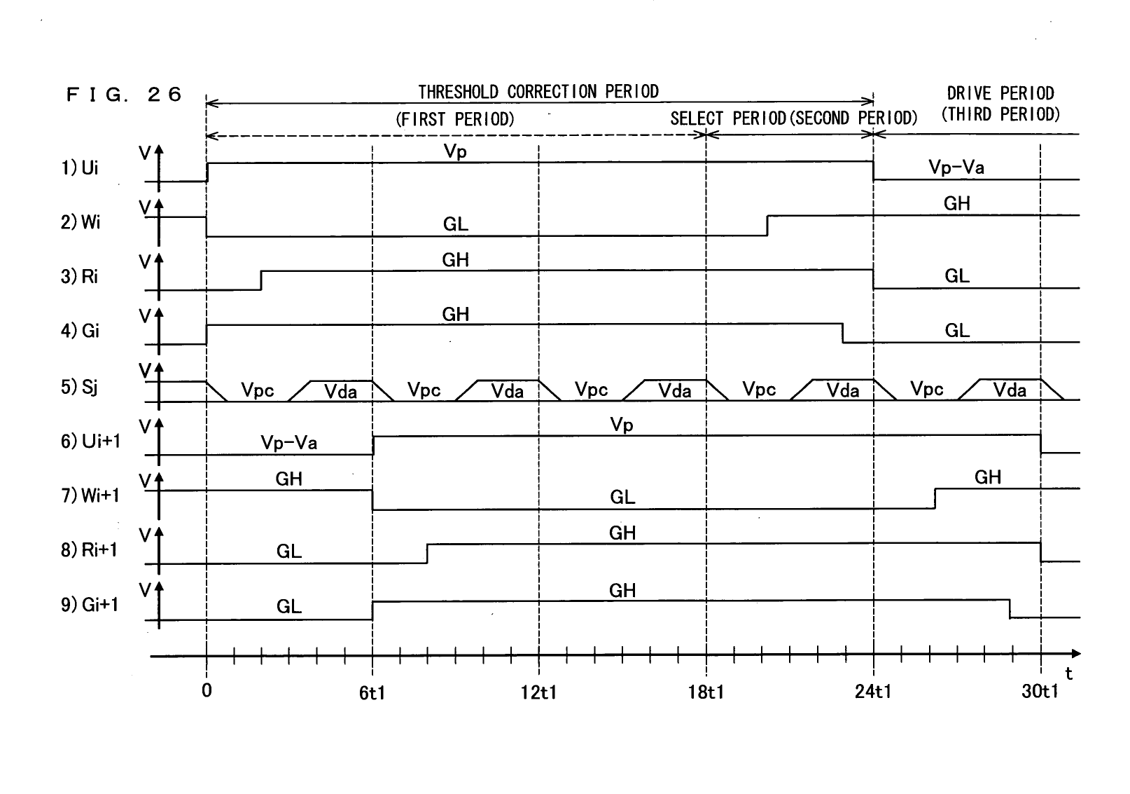

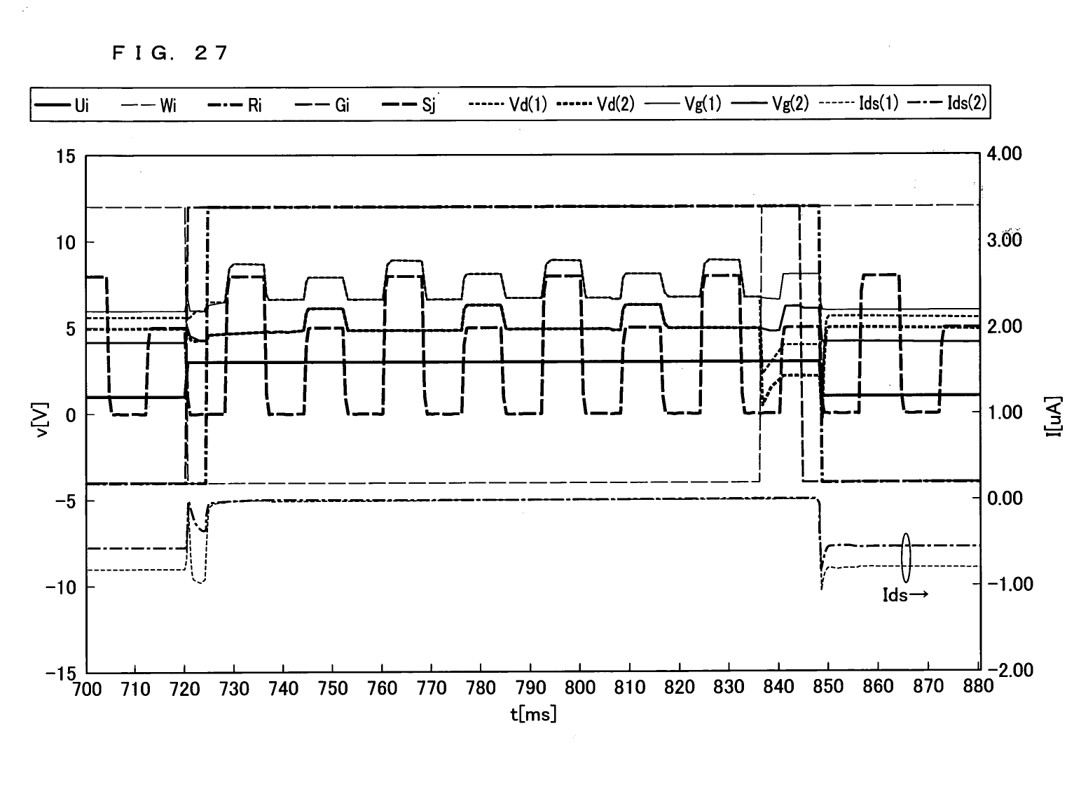

### BRIEF DESCRIPTION OF DRAWINGS

[FIG. 1] A block diagram for an embodiment of the present invention, illustrating a first structure of the display device.

[FIG. 2] A circuit diagram illustrating the structure of a pixel circuit in the display device of embodiment 1.

[FIG. 3] A timing chart illustrating voltages on lines and wires in the pixel circuit in FIG. 2.

[FIG. 4] A graph representing results of simulation of changes in the drain current of a driver TFT in the pixel circuit in FIG. 2.

[FIG. 5] A circuit diagram illustrating the structure of a variation example of the pixel circuit in FIG. 2.

[FIG. 6] A circuit diagram illustrating the structure of a pixel circuit in the display device of embodiment 2.

[FIG. 7] A timing chart illustrating voltages on lines and wires in the pixel circuit in FIG. 6.

[FIG. 8] A graph representing results of simulation of changes in the drain current of a driver TFT in the pixel circuit in FIG. 6.

[FIG. 9] A circuit diagram illustrating the structure of a pixel circuit in the display device of embodiment 3.

[FIG. 10] A timing chart illustrating voltages on lines and wires in the pixel circuit in FIG. 9.

[FIG. 11] A graph representing results of simulation of changes in the drain current of a driver TFT in the pixel circuit in FIG. 9.

[FIG. 12] A block diagram for an embodiment of the present invention, illustrating a second structure of the display device.

[FIG. 13] An diagram showing scan timings in a time division grayscale display scheme employed by the display device in FIG. 12.

[FIG. 14] A circuit diagram illustrating the structure of a pixel circuit in the display device in FIG. 12.

[FIG. 15] A timing chart illustrating voltages on lines and wires in the pixel circuit in FIG. 14.

[FIG. 16] A graph representing results of simulation of changes in the drain current of a driver TFT in the pixel circuit in FIG. 14.

[FIG. 17] A circuit diagram for conventional art, illustrating a first structure of a pixel circuit in a display device.

[FIG. 18] A timing chart illustrating the operation of the pixel circuit in FIG. 17.

[FIG. 19] A circuit diagram for conventional art, illustrating a second structure of a pixel circuit in a display device.

[FIG. 20] A graph representing the relationship between the average luminance and lifetime of an OLED.

[FIG. 21] A circuit diagram illustrating the structure of a pixel circuit in the display device of embodiment 5.

[FIG. 22] A timing chart illustrating voltages on lines and wires in the pixel circuit in FIG. 21.

[FIG. 23] A graph representing results of simulation of changes in the drain current of a driver TFT in the pixel circuit in FIG. 21.

[FIG. 24] A graph representing results of simulation for comparison with the simulation results in FIG. 23.

[FIG. 25] A circuit diagram illustrating the structure of a pixel circuit in the display device of embodiment 6.

[FIG. 26] A timing chart illustrating voltages on lines and wires in the pixel circuit in FIG. 25.

[FIG. 27] A graph representing results of simulation of changes in the drain current of a driver TFT in the pixel circuit in FIG. 25.

### BEST MODE FOR CARRYING OUT INVENTION

The following will describe embodiments of the present invention in reference to FIGS. 1 to 16 and 21 to 27.

The switching elements used in the present invention may be low-temperature polysilicon TFTs or CG (continuous grain) silicon TFTs, to name a few examples. They are CG silicon TFTs throughout the embodiments.

The structure of the CG silicon TFT is documented, for example, in SID '04 DIGEST, pp. 162-163. A process of manufacturing CG silicon TFTs is documented, for example, in “Continuous Grain Silicon Technology and its Applications for Active Matrix Display” (AM-LCD 2000, pp. 25-28, Semiconductor Energy Laboratory). Since both the structure of the CG silicon TFT and its manufacturing process are publicly known, no detailed description is given here.

The structure of the OLED (electro-optical element used in the embodiments) is documented, for example, in “Polymer Light-Emitting Diodes for Use in Flat Panel Display” (AM-LCD 01, pp. 211-214, Semiconductor Energy Laboratory), thus publicly known. No detailed description is given here.

### EMBODIMENT 1

The following will describe embodiment 1 in reference to FIGS. 1 to 5.

A display device 1 of the present embodiment includes pixel circuits (pixels) Aij (i=1 to n; j=1 to m), a source driver circuit 2, a gate driver circuit 3, precharge circuits 6(j), source lines Sj, and gate wire groups Gi as shown in FIG. 2. The pixel circuits are arranged in a matrix. The source driver circuit 2 and the precharge circuits 6(j) control voltages on the source lines Sj. The gate driver circuit 3 controls voltages on the gate wire groups Gi.

The pixel circuits Aij are each located where a source line Sj intersects a gate wire group Gi, forming a matrix as a whole.

The source driver circuit 2 includes an m-bit shift register 4 and m analog switches 5(1) to 5(m). A start pulse SP is fed to the first stage of the shift register 4, shifted in the shift register 4 in response to a clock clk, and output to the analog switches 5(1) to 5(m) simultaneously as source start pulses SSPs. The analog switch 5(j) closes in response to the source start pulse SSP fed from the shift register 4, thereby supplying, to the source line (data line) Sj, an analog data voltage Vda corresponding to the incoming display data Da for the pixel circuit Aij. After that, the analog switch 5(j) opens.

As outlined in the above, the source driver circuit 2 of the present embodiment has a similar structure to source driver circuits used, for example, in polysilicon TFT LCDs.

The gate driver circuit 3 includes a shift register circuit, a logic operation circuit, and a buffer circuit (none shown). An incoming start pulse YI is shifted in the shift register in response to a clock yck and subjected to a logic operation with a timing signal. A necessary voltage is output to gate wire groups Gi through the buffer. In the present embodiment, each gate wire group Gi includes control lines Wi and Ri and a voltage line Ui as will be detailed later.

The precharge circuit 6(j) outputs a reset voltage Vpc to the source line Sj in response to the incoming timing pulse PS.

The data voltage Vda, which corresponds to the display data Da for the pixel circuit Aij, is at any time equal to or greater than the reset voltage Vpc for the precharge circuit 6(j).

Next, the structure of the pixel circuit Aij will be described in reference to FIG. 1.

The pixel circuit Aij includes an OLED EL1, a driver TFT Q1, switching TFTs Q2 and Q3, and capacitors C1 and C2 as shown in FIG. 1. Although not shown in FIG. 2, a power supply line Vp for output of a voltage Vp and a common cathode Vcom for output of a voltage Vcom sufficiently lower than the voltage Vp are also provided on the display panel on which the pixel circuit Aij resides. “Vp” denotes both the power supply line and the voltage on it. “Vcom” denotes both the common cathode and the voltage on it. The gate wire groups Gi, already mentioned in relation to FIG. 2, here each include three lines: control lines Wi and Ri and a voltage line (first voltage line) Ui. The control lines Wi and Ri alternate between a HIGH voltage GH and a LOW voltage GL for output under the control of the gate driver circuit 3. The voltage line Ui alternates between a voltage which equals the power supply line Vp and a voltage Vp−Va which is lower than the voltage Vp for output of a first voltage under the control of the gate driver circuit 3.

The driver TFT Q1, the switching TFT Q3, and the OLED EL1 are connected in series in this order between the power supply line Vp and the common cathode Vcom, from the power supply line Vp toward the common cathode Vcom.

The OLED EL1 is a current-driven electro-optical element which shines with a luminance corresponding to electric current. Its anode is connected to the drain of the switching TFT Q3, and its cathode to the common cathode Vcom. The driver TFT (driver transistor) Q1 is a p-type TFT. Its drain current is fed to the OLED EL1 as a drive current. The drain current is controlled through the gate voltage relative to the source voltage of the driver TFT Q1. The driver transistor here is a TFT, which is not the only possibility. Any transistor may be used which supplies, as a drive current, an output current (drain current in the example above) controlled through the voltage of a current control terminal (gate in the example above) relative to a reference voltage terminal (source in the example above) to an electro-optical element like the OLED EL1 from a current output terminal (drain in the example above). An example is a field effect transistor formed on a semiconductor substrate. The switching TFT (second switching element) Q3 is a p-type TFT. The gate of the switching TFT Q3 is connected to the control line Ri so that the switching TFT Q3 switches on/off in accordance with the voltage on the control line Ri.

The capacitor (first capacitor) C1 is connected between the gate of the driver TFT Q1 and the voltage line Ui. In other words, in the present embodiment, the gate of the driver TFT Q1 is not connected to its source via the capacitor C1, but connected to the voltage line Ui provided separately from the power supply line Vp. The switching TFT (first switching element) Q2 is a p-type TFT and is connected between the gate and drain of the driver TFT Q1. The gate of the switching TFT Q2 is connected to the control line Wi so that the switching TFT Q2 switches on/off in accordance with the voltage on the control line Wi. The capacitor (second capacitor) C2 is connected between the drain of the driver TFT Q1 and the source line Sj. In other words, the present embodiment employs a first structure as a means of achieving during the first period a threshold state in which the output current of the driver transistor either starts or stops flowing.

The switching TFTs Q2 and Q3 are not necessarily TFTs. Any element that is capable of controlling switching (on/off) operation may be used. Examples are field effect transistors and bipolar transistors formed on a semiconductor substrate.

Next, the operation of the pixel circuit Aij constructed as above will be described in reference to the timing chart in FIG. 3.

The timing chart in FIG. 3 shows timings of voltage supply to 1) the voltage line Ui, 2) the control line Wi, 3) the control line Ri, 4) the source line S1, and 5) the source line Sm for the i-th row on which the pixel circuit Aij resides, and to 6) the voltage line Ui+1, 7) the control line Wi+1, and 8) the control line Ri+1 for the (i+1)-th row on which the pixel circuit A(i+1)j resides.

The pixel circuit Aij is in a threshold correction period from time 0 to time 24t1 and in a drive period from time 24t1 onwards. In addition, the threshold correction period is divided into the first period (time 0 to time 12t1) and the second period (time 12t1 to time 24t1). The second period may be referred to as a select period. The drive period may be referred to as the third period.

The voltage line Ui is set to Vp (the predetermined voltage is the power supply voltage Vp in the present embodiment) at time 0 to start the first period of the threshold correction period for the pixel circuit Aij. At time 0, the control line Wi is GH, and the control line Ri is GL. Therefore, the switching TFT Q2 is OFF, and the switching TFT Q3 is ON.

Next, at time t1, the control line Wi is set to GL, turning on the switching TFT Q2 and short-circuiting the gate and drain of the driver TFT Q1. Since the switching TFT Q3 is also ON at that time, the gate voltage of the driver TFT Q1 approaches the voltage Vcom on the common cathode Vcom, turning on the driver TFT Q1. Next, the control line Ri is set to GH at time 2t1, turning off the switching TFT Q3. That obstructs the current flowing from the source via drain of the driver TFT Q1 to the OLED EL1. The current instead diverts flowing from the drain to the gate, raising the gate voltage. That pushes the driver TFT Q1 into and beyond a threshold state, turning off driver TFT Q1. The pixel circuit Aij remains in this state until the second period (select period) starts.

The second period (select period) of the threshold correction period starts for the pixel circuit Aij at time 12t1. In the select period, the source line Sj is used to set up a drive current for the OLED EL1 in the pixel circuit Aij. At time 12t1, the voltages on the voltage line Ui and the control lines Wi and RI are the same as they were when the driver TFT Q1 entered the threshold state in the first period. At time 12t1, the precharge circuits 6 are turned on by a timing pulse PC, feeding the reset voltage Vpc to the source line Sj, to reset all the voltages on the source lines S1 to Sm (see FIG. 2). Thus, the voltage on the source line Sj is reset. As can be seen from a later discussion, the first period of the threshold correction period for the pixel circuit Aij coincides with the second period (select period) of the threshold correction period for the pixel circuit Ai−1j. Thus, when the voltage the source line Sj becomes equal to the reset voltage Vpc for the pixel circuit Aij, the voltage level is changed from the setting of the source line Sj in the pixel circuit Ai−1j to the data voltage Vda. Since Vpc≦Vda at any time, if the gate voltage of the driver TFT Q1 falls below Vp+Vth (Vth is negative) due to a voltage change on the source line Sj, there occurs current flowing through the driver TFT Q1. That raises the gate voltage to Vp+Vth, pushing the driver TFT Q1 into and beyond the threshold state, turning off the driver TFT Q1.

Next, at time 15t1, a pulse period of the timing pulse PS in FIG. 2 ends, turning off all the precharge circuits 6(1) to 6(m) at once. Thereafter, the voltages on the source lines Sj are maintained at the reset voltage Vpc until the data voltage Vda corresponding to the display data Da is supplied. After the precharge circuits 6(j) are turned off, the analog switches 5(1) to 5(m) are sequentially closed, supplying the data voltage Vda to the source lines S1 to Sm sequentially. As the analog switches 5(j) are opened after a predetermined period, the source lines Sj are maintained at the data voltage Vda. The data voltage Vda is an analog voltage corresponding to the display data Da of the pixel circuit Aij and may vary in magnitude. FIG. 3, however, shows only the periods when the source lines Sj are at the data voltage Vda for the sake of simplicity. FIG. 3 depicts an example in which the data voltage Vda starts to be supplied to the source line Sm at time 21t1, and the data voltage Vda is maintained until time 24t1 after the analog switch 5(m) is opened.

Since Vda≧Vpc, when the voltage on the source line Sj equals Vda, the gate voltage of the driver TFT Q1 rises (or maintained), keeping the driver TFT Q1 turned off. As a result, change in the gate voltage for the driver TFT Q1 is dictated by the ratio of the capacitances of the capacitors C1 and C2 and the difference between the data voltage Vda and the reset voltage Vpc.

Let the gate voltage of the driver TFT Q1 equal Vp+Vth+Vγ. The sum of the electric charge on one of the electrodes of the capacitor C1 which is connected to the gate of the TFT Q1 and the electric charge on one of the electrodes of the capacitor C2 which is connected to the gate of the TFT Q1 remains unchanged when the voltage on the source line Sj equals the reset voltage Vpc and when the voltage on the source line Sj equals the data voltage Vda. Thus,

C1×Vth+C2×(Vp+Vth−Vpc)=C1×(Vth+Vγ)+C2×(Vp+Vth+Vγ−Vda)

Therefore,

C2×(−Vpc)=C1×(Vγ)+C2×(Vγ−Vda)

Therefore,

Vγ=C2×(Vda−Vpc)/(C1+C2)

### In this manner, it would be appreciated that since Vda≧Vpc, the gate voltage of the driver TFT Q1 is as large as Vp+Vth+Vγ, which is more than or equal to Vp+Vth.

Thereafter, the control line Wi is set to GH at time 23t1, turning off the switching TFT Q2.

The third period, or the drive period, starts at time 24t1. At the same time, the voltage on the voltage line Ui is changed from Vp to Vp−Va, switching the control line Ri to GL. The gate voltage of the driver TFT Q1 changes from Vp+Vth+Vγ to Vp+Vth+Vγ−Va. If Vγ−Va≧0, the driver TFT Q1 is turned off. If Vγ−Va≦0, the driver TFT Q1 is turned on. The gate-to-source voltage Vth+Vγ−Va at this timing is the drive control voltage for the driver TFT Q1 by which a drive current is drawn to the OLED EL1 in a drive period at time 24t1 onwards.

Generally, if the drain-to-source voltage Vds of a TFT is greater than the gate-to-source voltage Vgs in terms of absolute value, the TFT is saturated, the current Ids through the TFT is

Ids=k×(Vgs−Vth)²

where k is a constant affected by the gate width, mobility, and other properties of the TFT. Since the gate voltage of the driver TFT Q1 equals Vp+Vth+Vγ−Va in the present example, the current Ids through the driver TFT Q1 is

Ids=k×(Vγ−Va)².

The OLED EL1 shines with a luminance in accordance with the current Ids until a next threshold correction period for the pixel circuit Aij.

In this manner, according to the present embodiment, the current Ids fed from the driver TFT Q1 to the OLED EL1 is determined through change in the voltage on the source line Sj (i.e., Vda−Vpc) and change in the voltage on the voltage line Ui (i.e., −Va), independently of the threshold voltage Vth of the driver TFT Q1.

FIG. 3, for convenience in representation, shows that when the first period of the threshold correction period for the pixel circuit Aij (a pixel circuit in the i-th row) ends, the first period of the threshold correction period for the pixel circuit Ai+1j (a pixel circuit in the (i+1)-th row) starts immediately. However, there may be provided several select periods until the first period of the threshold correction period for the pixel circuit Aij (a pixel circuit in the i-th row) ends. Similarly to the above case, when the second period (select period) of the threshold correction period for the pixel circuit Aij (a pixel circuit in the i-th row) ends, the second period (select period) of the threshold correction period for the pixel circuit Ai+1j (a pixel circuit in the (i+1)-th row) starts immediately. Similarly, the first period of the threshold correction period for the pixel circuit Aij is the second period (select period) of the threshold correction period for the pixel circuit Ai−1j (a pixel circuit in the (i−1)-th row). For convenience of description, FIG. 3 shows that time starts with the threshold correction period for the pixel circuit Aij.

FIG. 4 shows results of simulation of the current Ids based on properties of an OLED (GL=−4 V, GH=12 V, Vcom=0 V, Vp=12 V, Vpc=0 V, Va=2 V, Vda=5 V, Cl=500 fF, C2=100 fF). The threshold correction period (first period) for each pixel Aij in the simulation is four select periods long.

In FIG. 4, the current Ids(1) corresponds to the pixel circuit Ai and to a case where the absolute value of the threshold voltage Vth of the driver TFT Q1 is a minimum (=Vth(min)) and the mobility μ is a maximum. The current Ids(2) corresponds to the pixel circuit Aim and to a case where the absolute value of the threshold voltage Vth of the driver TFT Q1 is a maximum (=Vth(max)) and the mobility μ is a minimum. The current Ids(3) corresponds to the pixel circuit A(i+1)1 and to a case where the absolute value of the threshold voltage Vth of the driver TFT Q1 is a maximum (=Vth(max)) and the mobility μ is a minimum. The current Ids(4) corresponds to the pixel circuit A(i+1)m and to a case where the absolute value of the threshold voltage Vth of the driver TFT Q1 is a minimum (=Vth(min)) and the mobility μ is a maximum.

From the results of the simulation in FIG. 4, the current Ids(1) equals about −2.27 μA, the current Ids(2) about −1.53 μA, the current Ids(3) about −1.82 μA, and the current Ids(4) about −1.84 μA.

One select period is 12t1, and 1t1 equals 2 μs in FIG. 4. It is 4t1 of each select period that the source line S1 for the pixel circuit Ai1 and the pixel circuit A(i+1)1 changes from the reset voltage Vpc to the data voltage Vda. It is 8t1 of each select period that the source line Sm for the pixel circuit Aim and the pixel circuit A(i+1)m changes from the reset voltage Vpc to the data voltage Vda.

In this case, the current Ids for the pixel circuit Ai1 and the pixel circuit Aim varies from −1.53 μA to −2.27 μA. In contrast, the current Ids for the pixel circuit Ai1 and the pixel circuit A(i+1)1 for which the timing when the source lines S1 changes from the reset voltage Vpc to the data voltage Vda is 4t1 of each select period varies from −1.82 μA to −2.27 μA.

In this manner, it would be appreciated that although the current Ids varies differently for the pixel circuit Ai1 and for the pixel circuit Aim, the present embodiment enables setting up of the current Ids fed from the driver TFT Q1 to the OLED EL1, independently of the threshold voltage Vth of the driver TFT Q1.

Especially, using the pixel circuit Aij in FIG. 1 of the present embodiment, a current flow from the driver TFT Q1 to the OLED EL1 can be set up with three TFTs and two capacitors. The embodiment contains a reduced number of elements per pixel over conventional art and achieves an increased aperture ratio when applied to a bottom emission structure. Also, the embodiment provides a display device with an increased resolution when applied to a top emission structure.

The pixel circuit Aij in FIG. 1 is built around p-type TFTs. In some cases, however, only amorphous silicon or other n-type TFTs are available. When that is the case, the pixel circuit Aij should be reversed in polarity (see FIG. 5) as contrasted with the pixel circuit in FIG. 1.

Specifically, the pixel circuit Aij in FIG. 5 includes an OLED (electro-optical element) EL1, a switching TFT (second switch transistor) Q6, and a driver TFT (driver transistor) Q4 connected in series in this order between the common cathode Vcom and the power supply line Vp, from the common cathode Vcom toward the power supply line Vp. Note that the voltage Vp is sufficiently smaller than the voltage Vcom.

There is a capacitor (first capacitor) C3 connected between the gate of the driver TFT Q4 and voltage line (first voltage line) Ui and a switching TFT (first switching element) Q5 connected between the gate and drain of the driver TFT Q4. A capacitor (second capacitor) C4 is connected between the drain of the driver TFT Q4 and the source line Sj.

In the pixel circuit Aij, the driver TFT Q4 and the switching TFTs Q5 and Q6 are n-type TFTs. A control line Wi is connected to the gate of the switching TFT Q5, and a control line Ri to the gate of the switching TFT Q6. The voltages supplied to the control lines Wi and Ri and the voltage line Ui are upside down from those in FIG. 3. No further description will be given here. When the driver TFT is an n-type, Vda≦Vpc at any time, which is opposite to the case with a p-type.

In this manner, the present invention is effective with both p-type and n-type driver TFTs.

### EMBODIMENT 2

The following will describe embodiment 2 in reference to FIGS. 6 to 8. The members of the present embodiment that have the same arrangement and function as members of embodiment 1, and that are mentioned in that embodiment are indicated by the same reference numerals and description thereof is omitted.

A display device of the present embodiment has the same block arrangement as the display device 1 of embodiment 1. Detailed description thereof is omitted here.

FIG. 6 shows the structure of the pixel circuit Aij of the present embodiment.

In FIG. 6, each gate wire group Gi (appears also in FIG. 2) includes three lines, that is, a control line Wi and voltage lines Ui and VRi. The voltage line (second voltage line) VRi alternates between a voltage Vc and a voltage Ve for output of a second voltage under the control of the gate driver 3. The voltage Vc is sufficiently lower than the voltage Vp. The voltage Ve is sufficiently higher than the voltage Vc. In addition, Ve is substantially equal to Vp.

The pixel circuit Aij includes an OLED EL1, a driver TFT Q1, a switching TFT Q2, and capacitors C1 and C2. The driver TFT Q1 and the OLED EL1 are connected in series in this order between the power supply line Vp and the voltage line VRi, from the power supply line Vp toward the voltage line VRi. Therefore, in the present embodiment, one of the terminals (anode) of the OLED EL1 is connected to the drain of the driver TFT Q1. The other terminal (cathode) is connected to the voltage line VRi. The capacitor C1 connected between the gate of the driver TFT Q1 and the voltage line (first voltage line) Ui. The switching TFT Q2 is connected between the gate and drain of the driver TFT Q1. The capacitor C2 is connected to between the drain of the driver TF Q1 and the source line Sj.

The gate of the switching TFT Q2 is connected to the control line Wi. In other words, the present embodiment employs a second structure as a means of achieving during the first period a threshold state in which the output current of the driver transistor either starts or stops flowing.

Next, the operation of the pixel circuit Aij constructed as above will be described in reference to the timing chart in FIG. 7.

The timing chart in FIG. 7 shows timings of voltage supply to 1) the voltage line Ui, 2) the control line Wi, 3) the voltage line VRi, 4) the source line S1, and 5) the source line Sm for the i-th row on which the pixel circuit Aij resides, and to 6) the voltage line Ui+1, 7) the control line Wi+1, and 8) the voltage line VRi+1 for the (i+1)-th row on which the pixel circuit A(i+1)j resides.

The pixel circuit Aij is in a threshold correction period from time 0 to time 24t1 and in a drive period from time 24t1 onwards. In addition, the threshold correction period is divided into the first period (time 0 to time 12t1) and the second period (time 12t1 to time 24t1). The second period may be referred to as a select period. The drive period may be referred to as the third period.

The voltage line Ui is set to Vp (the predetermined voltage is the power supply voltage Vp in the present embodiment) at time 0 to start the first period of the threshold correction period for the pixel circuit Aij. At time 0, the control line Wi is GH, and the control line VRi is Vc. Therefore, the switching TFT Q2 is OFF.

Next, at time t1, the control line Wi is set to GL, turning on the switching TFT Q2 and short-circuiting the gate and drain of the driver TFT Q1. Since the voltage on the voltage line VRi is Vc, the OLED EL1 is forward biased, and the gate voltage of the driver TFT Q1 approaches the voltage Vc of the voltage line VRi, turning on the driver TFT Q1.

Next, the voltage of the voltage line VRi is set to Ve at time 2t1. Since the voltage Ve is substantially the same as the voltage Vp, the OLED EL1 is reverse biased or has almost no current flow therethrough. That obstructs the current flowing from the source via drain of the driver TFT Q1 to the OLED EL1. The current instead diverts flowing from the drain to gate of the driver TFT Q1, raising the gate voltage. That pushes the driver TFT Q1 into and beyond a threshold state, turning off the driver TFT Q1. The pixel circuit Aij remains in this state until the second period (select period) starts.

In this situation, if Ve was greater than Vp and the capacitance produced of the OLED EL1 was so much larger than the capacitance of the capacitors C1 and C2 that it could not be ignored, a large voltage change would travel via the capacitance of the OLED EL1 to the anode side of the OLED EL1 at the moment the voltage line VRi changes from Vc to Ve, raising the gate voltage of the driver TFT Q1 in excess of Vp+Vth. Therefore, the absolute value of the gate-to-source voltage of the driver TFT Q1 would be less than the absolute value of the threshold voltage, the driver TFT Q1 thereby being turned off. However, since Ve is substantially the same as Vp in the present embodiment, a much smaller voltage change travels to the anode side of the OLED EL1 at the moment the voltage of the voltage line VRi changes from Vc to Ve. The gate voltage of the driver TFT Q1 is less than Vp+Vth (Vth is negative). Therefore, the gate voltage thereafter rises, certainly pushing the driver TFT Q1 into and beyond a threshold state. That turns off the driver TFT Q1.

The second period (select period) of the threshold correction period starts for the pixel circuit Aij at time 12t1. In the select period, the source line Sj is used to set up a drive current for the OLED EL1 in the pixel circuit Aij. At time 12t1, the voltages on the voltage lines Ui and VRi and the control line Wi are the same as they were when the driver TFT Q1 entered the threshold state in the threshold correction period. At time 12t1, the precharge circuits 6 are turned on by a timing pulse PC, feeding the reset voltage Vpc to the source line Sj, to reset all the voltages on the source lines S1 to Sm (see FIG. 2). Thus, the voltage on the source line Sj is reset. In this situation, the gate voltage of the driver TFT Q1 becomes Vp+Vth which corresponds to the threshold state, turning off the driver TFT Q1.

Next, at time 15t1, a pulse period of the timing pulse PS in FIG. 2 ends, turning off all the precharge circuits 6(1) to 6(m) at once. Thereafter, the voltages of the source lines Sj are maintained at the reset voltage Vpc until the data voltage Vda corresponding to the display data Da is supplied. After the precharge circuits 6(j) are turned off, the analog switches 5(1) to 5(m) are sequentially closed, supplying the data voltage Vda to the source lines S1 to Sm sequentially. As the analog switches 5(j) are opened after a predetermined period, the source lines Sj are maintained at the data voltage Vda. The data voltage Vda is an analog voltage corresponding to the display data Da of the pixel circuit Aij and may vary in magnitude. FIG. 7, however, shows only the periods when the source lines Sj are at the data voltage Vda for the sake of simplicity. FIG. 7 depicts an example in which the data voltage Vda starts to be supplied to the source line Sm at time 21t1, and the data voltage Vda is maintained until time 24t1 after the analog switch 5(m) is opened.

Since Vda≧Vpc at any time, when the voltage on the source line Sj equals Vda, the gate voltage of the driver TFT Q1 rises, keeping the driver TFT Q1 turned off. As a result, the gate voltage of the driver TFT Q1 equals Vp+Vth+Vγ as in embodiment 1.

The control line Wi is set to GH at time 23t1, turning off the switching TFT Q2. The third period, or the drive period, starts at time 24t1. At the same time, the voltage on the voltage line Ui is changed from Vp to Vp−Va, switching the voltage on the voltage line VRi back to Vc. The gate voltage of the driver TFT Q1 changes from Vp+Vth+Vγ to Vp+Vth+Vγ−Va. If Vγ−Va≧0, the driver TFT Q1 is turned off. If Vγ−Va<0, the driver TFT Q1 is turned on. The gate-to-source voltage Vth+Vγ−Va at this timing is the drive control voltage for the driver TFT Q1 by which a drive current is drawn to the OLED EL1 in a drive period at time 24t1 onwards. The current Ids through the driver TFT Q1 is

Ids=k×(Vγ−Va)²

as in embodiment 1.

In this manner, according to the present embodiment, the current Ids fed from the driver TFT Q1 to the OLED EL1 is determined through change in the voltage on the source line Sj (i.e., Vda−Vpc) and change in the voltage on the voltage line Ui (i.e., −Va), independently of the threshold voltage Vth of the driver TFT Q1.

The first period and the second period (select period) of the threshold correction period are executed in the same sequence for each row as in embodiment 1.

FIG. 8 shows results of simulation of the current Ids based on properties of an OLED (GL=−4 V, GH=12 V, Vcom=0 V, Vp=12 V, Vpc=0 V, Va=2 V, Vda=5 V, C1=500 fF, C2=100 fF). The threshold correction period (first period) for each pixel Aij in the simulation is four select periods long.

In FIG. 8, the current Ids(1) corresponds to the pixel circuit Ai and to a case where the absolute value of the threshold voltage Vth of the driver TFT Q1 is a minimum (=Vth(min)) and the mobility μ is a maximum. The current Ids(2) corresponds to the pixel circuit Aim and to a case where the absolute value of the threshold voltage Vth of the driver TFT Q1 is a maximum (=Vth(max)) and the mobility μ is a minimum. The current Ids(3) corresponds to the pixel circuit A(i+1)1 and to a case where the absolute value of the threshold voltage Vth of the driver TFT Q1 is a maximum (=Vth(max)) and the mobility μ is a minimum. The current Ids(4) corresponds to the pixel circuit A(i+1)m and to a case where the absolute value of the threshold voltage Vth of the driver TFT Q1 is a minimum (=Vth(min)) and the mobility μ is a maximum.

From the results of the simulation in FIG. 8, the current Ids(1) equals about −2.28 μA, the current Ids(2) about −1.48 μA, the current Ids(3) about −1.76 μA, and the current Ids(4) about −1.88 μA.

One select period is 12t1, and 1t1 equals 2 μs also in FIG. 8. It is 4t1 of each select period that the source line S1 for the pixel circuit Ai1 and the pixel circuit A(i+1)1 changes from the reset voltage Vpc to the data voltage Vda. It is 8t1 of each select period that the source line Sm for the pixel circuit Aim and the pixel circuit A(i+1)m changes from the reset voltage Vpc to the data voltage Vda.

It would be appreciated that the present embodiment enables setting up of the current Ids fed from the driver TFT Q1 to the OLED EL1, independently of the threshold voltage Vth of the driver TFT Q1. Especially, using the pixel circuit Aij in FIG. 6, a current flow from the driver TFT Q1 to the OLED EL1 can be set up with two TFTs and two capacitors.

The voltage line VRi, connected to the cathode of the OLED EL1, is formed by separating the cathode electrode formed on the OLED EL1 using, for example, a cathode separator; there is no need to provide the voltage line VRi in the TFT substrate.

This reduces the number of elements per pixel even in comparison with embodiment 1. The embodiment achieves an increased aperture ratio when applied to a bottom emission structure. Also, the embodiment allows for extending the lifetime of the OLED. In addition, the embodiment provides a display device with an increased resolution when applied to a top emission structure.

As can be seen from the foregoing, the gate voltage of the driver TFT Q1 is less than Vp+Vth in the simulation when the voltage line VRi is changed from Vc to Ve. However, this is possibly a contribution from the fact that the capacitance produced of the OLED EL1 used in the simulation in accordance with the voltage Ve on the voltage line VRi is sufficiently smaller than the capacitance of the capacitors C1 and C2, as well as a contribution from the voltage Ve which is made substantially equal to the voltage Vp.

Furthermore, a comparison of the results of simulation in FIG. 8 and those in FIG. 4 demonstrates that the current Ids for the pixel circuit Ai1 and the pixel circuit Aim varies from −1.48 μA to −2.28 μA, an increase of 0.06 μA. The current Ids for the pixel circuit Ai and the pixel circuit A(i+1)1, for which the voltage on the source line S1 changes from Vpc to Vda at 4t1, also varies from −1.76 μA to −2.28 μA, an increase of 0.07 μA.

This is because the voltage on the voltage line VRi is changed from Vc to Ve (Ve is sufficiently larger than Vc) with the gate and drain of the driver TFT Q1 being short-circuited.

### EMBODIMENT 3

The following will describe embodiment 3 in reference to FIGS. 9 to 11. The members of the present embodiment that have the same arrangement and function as members of embodiments 1 and 2, and that are mentioned in that embodiments are indicated by the same reference numerals and description thereof is omitted.

A display device of the present embodiment has the same block arrangement as the display device 1 of embodiment 1. Detailed description thereof is omitted here.

FIG. 9 shows the structure of the pixel circuit Aij of the present embodiment.

In FIG. 9, each gate wire group Gi (appears also in FIG. 2) includes four lines, that is, control lines Wi and Pi, a voltage line Ui, and a voltage line VRi. The control line Pi alternates between a HIGH voltage GH and a LOW voltage GL for output under the control of the gate driver circuit 3.

The pixel circuit Aij in FIG. 9 is the same as the pixel circuit Aij in FIG. 6, but includes an additional switching TFT (third switching element) Q7 connected parallel to the capacitor C2. The switching TFT Q7 is a p-type TFT. The gate of the switching TFT Q7 is connected to the control line Pi.

Next, the operation of the pixel circuit Aij constructed as above will be described in reference to the timing chart in FIG. 10.

The timing chart in FIG. 10 shows timings of voltage supply to 1) the voltage line Ui, 2) the control line Wi, 3) the voltage line VRi, 4) the control line Pi, 5) the source line S1, and 6) the source line Sm for the i-th row on which the pixel circuit Aij resides, and to 7) the voltage line Ui+1, 8) the control line Wi+1, 9) the voltage line VRi+1, and 10) the control line Pi+1 for the (i+1)-th row on which the pixel circuit A(i+1)j resides.

The pixel circuit Aij is in a threshold correction period from time 0 to time 24t1 and in a drive period from time 24t1 onwards. In addition, the threshold correction period is divided into the first period (time 0 to time 12t1) and the second period (time 12t1 to time 24t1) The second period may be referred to as a select period. The display period may be referred to as the third period.

The voltage line Ui is set to Vp, and the control line VRi is set to Ve, at time 0 to start the first period of the threshold correction period for the pixel circuit Aij. Since Ve is substantially the same as Vp, the OLED EL1 is reverse biased or has almost no current flow therethrough. The control lines Wi and Pi are GH at time 0. Therefore, the switching TFTs Q2 and Q7 are OFF.

Next, at time t1, the control line Wi is set to GL, turning on the switching TFT Q2 and short-circuiting the gate and drain of the driver TFT Q1. At the same time, the control line Pi is set to GL, turning on the switching TFT Q7. The voltage on the source line Sj becomes equal to the reset voltage Vpc to execute the select period for the pixel circuit Ai−1j, the gate voltage of the driver TFT Q1 and the anode voltage of the OLED EL1 equal Vpc. Since Vpc is sufficiently smaller than Vp, the driver TFT Q1 is turned on.

The control line Pi is set to GH at time 2t1, turning off the switching TFT Q7. That causes electric current to flow from the drain to gate of the driver TFT Q1, increasing the gate voltage. The increased gate voltage in turn pushes the driver TFT Q1 into and beyond a threshold state, turning off the driver TFT Q1. The pixel circuit Aij remains in this state until the second period (select period) starts.

The second period (select period) of the threshold correction period starts for the pixel circuit Aij at time 12t1. In the select period, the source line Sj is used to set up a drive current for the OLED EL1 in the pixel circuit Aij. At time 12t1, the voltages on the voltage lines Ui and VR1 and the control lines Wi and Pi are the same as they were when the driver TFT Q1 entered the threshold state in the threshold correction period. At time 12t1, the precharge circuits 6 are turned on by a timing pulse PC, feeding the reset voltage Vpc to the source line Sj, to reset all the voltages on the source lines S1 to Sm (see FIG. 2). Thus, the voltage on the source lines Sj is reset. At this time, the gate voltage of the driver TFT Q1 is Vp+Vth which corresponds to the threshold state. The driver TFT Q1 is OFF.

Next, at time 15t1, a pulse period of the timing pulse PS in FIG. 2 ends, turning off all the precharge circuits 6(1) to 6(m) at once. Thereafter, the voltages on the source lines Sj are maintained at the reset voltage Vpc until the data voltage Vda corresponding to the display data Da is supplied. After the precharge circuits 6(j) are turned off, the analog switches 5(1) to 5(m) are sequentially closed, supplying the data voltage Vda to the source lines S1 to Sm sequentially. As the analog switches 5(j) are opened after a predetermined period, the source lines Sj are maintained at the data voltage Vda. The data voltage Vda is an analog voltage corresponding to the display data Da of the pixel circuit Aij and may vary in magnitude. FIG. 10, however, shows only the periods when the source lines Sj are at the data voltage Vda for the sake of simplicity. FIG. 10 depicts an example in which the data voltage Vda starts to be supplied to the source line Sm at time 21t1, and the data voltage Vda is maintained until time 24t1 after the analog switch 5(m) is opened.

Since Vda≧Vpc at any time, when the voltage on the source line Sj equals Vda, the gate voltage of the driver TFT Q1 rises, keeping the driver TFT Q1 turned off. As a result, the gate voltage of the driver TFT Q1 equals Vp+Vth+Vγ as in embodiment 1.

The control line Wi is set to GH at time 23t1, turning off the switching TFT Q2. The third period, or the display period, starts at time 24t1. At the same time, the voltage on the voltage line Ui is changed from Vp to Vp−Va, switching the voltage on the voltage line VRi back to Vc. The gate voltage of the driver TFT Q1 changes from Vp+Vth+Vγ to Vp+Vth+Vγ−Va. If Vγ−Va≧0, the driver TFT Q1 is turned off. If Vγ−Va<0, the driver TFT Q1 is turned on. The gate-to-source voltage Vth+Vγ−Va at this timing is the drive control voltage for the driver TFT Q1 by which a drive current is drawn to the OLED EL1 in a drive period at time 24t1 onwards. The current Ids through the driver TFT Q1 is

Ids=k×(Vγ−Va)²

as in embodiment 1.

In this manner, according to the present embodiment, the current Ids fed from the driver TFT Q1 to the OLED EL1 is determined through change in the voltage on the source line Sj (i.e., Vda−Vpc) and change in the voltage on the voltage line Ui (i.e., −Va), independently of the threshold voltage Vth of the driver TFT Q1.

The first period and the second period (select period) of the threshold correction period are executed in the same sequence for each row as in embodiment 1.

FIG. 11 shows results of simulation of the current Ids based on properties of an OLED (GL=−4 V, GH=12 V, Vcom=0 V, Vp=12 V, Vpc=0 V, Va=2 V, Vda=5 V, C1=500 fF, and C2=100 fF).

The current Ids(1) corresponds to the pixel circuit A11 and to a case where the absolute value of the threshold voltage Vth of the driver TFT Q1 is a minimum (=Vth(min)) and the mobility μ is a maximum. The current Ids(2) corresponds to the pixel circuit Aim and to a case where the absolute value of the threshold voltage Vth of the driver TFT Q1 is a maximum (=Vth(max)) and the mobility μ is a minimum. The current Ids(3) corresponds to the pixel circuit A(i+1)1 and to a case where the absolute value of the threshold voltage Vth of the driver TFT Q1 is a maximum (=Vth(max)) and the mobility μ is a minimum. The current Ids(4) corresponds to the pixel circuit A(i+1)m and to a case where the absolute value of the threshold voltage Vth of the driver TFT Q1 is a minimum (=Vth(min)) and the mobility μ is a maximum.

From the results of the simulation in FIG. 11, the current Ids(1) equals about −2.33 μA, the current Ids(2) about −1.50 μA, the current Ids(3) about −1.81 μA, and the current Ids(4) about −1.88 μA.

One select period is 12t1, and 1t1 equals 2 μs also in FIG. 11. It is 4t1 of each select period that the source line S1 for the pixel circuit Ai and the pixel circuit A(i+1)1 changes from the reset voltage Vpc to the data voltage Vda. It is 8t1 of each select period that the source line Sm for the pixel circuit Aim and the pixel circuit A(i+1)m changes from the reset voltage Vpc to the data voltage Vda.

According to the present embodiment, even if the capacitance of the OLED EL1 is so much larger than the capacitance of the capacitors C1 and C2 that it cannot be ignored, the gate voltage of the driving TFT Q1 can be set to the reset voltage Vpc after the voltage line VRi is changed from Vc to Ve. Thus, the gate voltage of the driver TFT Q1 can be reliably made smaller than Vp+Vth. That can be followed by a rise in the gate voltage, which reliably pushes the driver TFT Q1 into and beyond a threshold state and turns off the driver TFT Q1.

In this manner, using the pixel circuit Aj in FIG. 9, a current flow from the driver TFT Q1 to the OLED EL1 can be set up with three TFTs and two capacitors. This reduces the number of elements per pixel as in embodiment 1. The embodiment achieves an increased aperture ratio when applied to a bottom emission structure. Also, the embodiment allows for extending the lifetime of the OLED. In addition, the embodiment provides a display device with an increased resolution when applied to a top emission structure.

However, a comparison of the results of simulation in FIG. 11 and those in FIG. 8 demonstrates that the current Ids for the pixel circuit Ai1 and the pixel circuit Aim varies from −1.50 μA to −2.33 μA, an additional increase of 0.03 μA. The current Ids for the pixel circuit Ai1 and the pixel circuit A(i+1)1, for which the voltage on the source line S1 changes from the reset voltage Vpc to the data voltage Vda at 4t1 of each select period, also varies from −1.81 μA to −2.33 μA. No change is observed.

The OLED capacitance was small in the simulation. The results of the simulation however demonstrate that the above structure is sufficient to realize the present invention.

The switching TFT Q7 is connected parallel to the capacitor C2 in FIG. 6 in the present embodiment. Alternatively, the switching TFT may be connected parallel to the capacitor C2 in FIG. 1 or parallel to the capacitor C4 in FIG. 5. In those cases, the switching TFT Q3 in FIG. 1 and the switching TFT Q6 in FIG. 5 are always turned off in the first period of the threshold correction period. Still referring to those cases, the pixel circuit contains a reduced number of elements (four TFTs and two capacitors) over conventional cases.

### EMBODIMENT 4

The following will describe embodiment 4 in reference to FIGS. 12 to 16.

The results of simulation in embodiments 1 to 3 demonstrate that the variation of the current Ids between the pixel circuit Ai1 and the pixel circuit Aim is greater than the variation of the current Ids between the pixel circuit Ai1 and the pixel circuit A(i+1)1. This is an effect of the timing at which the voltage on the source line S1 changes from the reset voltage Vpc to the data voltage Vda. Therefore, the source lines S1 to Sm change to the data voltage Vda preferably at the same time. The following will describe such a display device.

A display device 21 of the present embodiment, as shown in FIG. 12, includes pixel circuits (pixels) Aij (i=1 to n; j=1 to m), a source driver circuit 8, a gate driver circuit 9, source lines Sj, and gate wire groups Gi. The pixel circuits are arranged in a matrix. The source driver circuit 8 controls voltages on the source lines Sj. The gate driver circuit 9 controls voltages on the gate wire groups Gi.

The pixel circuit Aij are each located where a source line Sj intersects a gate wire group Gi, forming a matrix as a whole.

The source driver circuit 8 includes an m-bit shift register 4, an m-bit register 10, an m-bit latch 11, and m analog switches 12(1) to 12(m).

Hence, in the source driver circuit 8, a start pulse SP is fed to the first stage of the m-bit shift register 4, shifted in the shift register 4 in response to a clock clk, and output to the register 10 simultaneously as source start pulses SSPs. The m-bit register 10 registers incoming data Dx for associated source lines Sj in response to the source start pulses SSPs fed from the shift register 4. The latch 11 latches the registered m-bit data according to a latch pulse LP for simultaneous output to the analog switches 12(1) to 12(m). The analog switches 12(j) select voltages corresponding to the incoming data Dx for output to the source lines Sj.

The display device 21 is assumed to receive 1-bit digital data as the data signal Dx. Under that assumption, the analog switch 12(j) can select the following voltages: Vr, Vg, Vb for emission, Voff for non-emission, and Vpc (reset voltage; detailed later). No distinction will be made between Vr, Vg, Vb in following description. These emission voltages will be denoted by data voltages Vdk (k=1, 2, 3) together with non-emission voltage Voff. In addition, Vdk≧Vpc.

The gate driver circuit 9 includes a shift register circuit, an address decoder, a logic operation circuit, and a buffer circuit (none shown). An incoming start pulse YI is shifted in the shift register in the gate driver circuit 9 in response to a clock yck for output of a timing signal to the logic operation circuit. At the same time, an address signal Add is fed to the address decoder for output of a timing signal to the logic operation circuit. The logic operation circuit performs logic operation on the signal outputs from the shift register circuit and the address decoder and supplies necessary voltages to associated gate wire groups Gi through a buffer.

The display device 21 produces a grayscale display by time division.

Specifically, when the pixel circuit Aij produces a display from 3-bit data as shown in FIG. 13, each frame period is divided into three subframe periods TD1 to TD3 and threshold correction periods preceding the subframe periods. Data D1, D2, D3 is sequentially fed to the source lines Sj as on 14). The association between the data Dk (k=1, 2, 3) and the pixel circuits Aij is indicated by Ui on 1) to 13). The pixel circuits Aij are turned on/off in accordance with the data D1 to D3 in the three subframe periods TD1 to TD3, thereby achieving a grayscale display.

FIG. 14 shows the structure of the pixel circuit Aij employed in the present embodiment. The pixel circuit Aij here is made up of three pixel circuits Aij of FIG. 1, one each for red, green, and blue, placed side by side. (R is displayed by a pixel circuit Aijr, G by a pixel circuit Aijg, and B by a pixel circuit Aijb). Accordingly, description of the structure of the pixel circuit Aij is omitted. Each source line Sj is replaced by three (RGB) source lines: a source line Sjr for red, a source line Sjg for green, and a source line Sjb for blue. This configuration is applicable also to embodiments 1 to 3.

Next, the operation of the pixel circuit Aij constructed as above will be described in reference to the timing chart in FIG. 15.

The timing chart in FIG. 15 shows timings of voltage supply to 1) the voltage line Ui, 2) the control line Wi, 3) the control line Ri, and 4) the source line Sj for the i-th row on which the pixel circuit Aij resides, and to 7) the voltage line Ui+1, 8) the control line Wi+1, and 9) the control line Ri+1 for the (i+1)-th row on which the pixel circuit A(i+1)j resides.

The pixel circuit Aij is in a threshold correction period from time 0 to time 36t1 and in a display period from time 36t1 onwards. In addition, the threshold correction period is divided into the first period (time 0 to time 18t1) and the second period (time 18t1 to time 36t1). One of the periods in the second period, time 19t1 to time 23t1, time 25t1 to time 29t1, or time 31t1 to time 35t1, may be referred to as a select period. Time 31t1 to time 35t1 is the select period in the following example. The display period may be referred to the third period.

The voltage line Ui is set to Vp at initial time 0 in the first period of the threshold correction period. A reset voltage Vpc is supplied to the source line Sj at the same time. At time 0, the control line Ri is GL. Next, at time t1, the control line Wi is set to GL, turning on the switching TFT Q2 and short-circuiting the gate and drain of the driver TFT Q1. Since the control line Ri is GL, the switching TFT Q3 is ON. The gate voltage of the driver TFT Q1 thus approaches the voltage Vcom of the common cathode Vcom, turning on the driver TFT Q1.

Next, the control line Ri is set to GH at time 2t1, turning off the switching TFT Q3. That obstructs the current flowing from the source via drain of the driver TFT Q1 to the OLED EL1. The current instead diverts flowing from the drain to the gate of the driver TFT Q1, raising the gate voltage of the driver TFT Q1. That pushes the driver TFT Q1 into an beyond a threshold state, turning off the driver TFT Q1.

At time 3t1, a data voltage Vd1 is fed from the analog switch 12(j) to the source line Si. Note that Vdk≧Vpc (k=1, 2, 3).

Thereafter, the source line Sj is fed with the reset voltage Vpc at time 6t1 and a data voltage Vd2 at time 9t1. The source line Sj is fed with the reset voltage Vpc at time 12t1 and a data voltage Vd3 at time 15t1. The data voltage Vdk supplied to the source line Sj in that period is destined for another pixel circuit Akj (k≠i).

The second period of the threshold correction period starts at time 18t1. At the same time, the source line Sj is fed with the reset voltage Vpc. After that, the control line Wi is set to GH, temporarily turning off the switching TFT Q2. Thus, when the source line Sj is the reset voltage Vpc, the gate voltage of the driver TFT Q1 equals Vp+Vth (Vth is negative). The driver TFT Q1 is turned off.

Since the present embodiment describes a select period corresponding to bit 3, the select period for the pixel circuit Aij is from time 31t1 to time 35t1. To describe a select period corresponding to bit 2, the select period for the pixel circuit Aij is from time 25t1 to time 29t1. To describe a select period corresponding to bit 1, the select period for the pixel circuit Aij is from time 19t1 to time 23t1.

When the select period for the pixel circuit Aij is from time 31t1 to time 35t1, the source line Sj is fed with the reset voltage Vpc at time 30t1, the control line Wi is set to GL at time 31t1, turning on the switching TFT Q2. At time 33t1, the source line Sj is fed with the data voltage Vd3. At time 35t1 when the voltage on the source line Sj is the data voltage Vd3, the control line Wi is set to GH, turning off the switching TFT Q2.

Since Vdk≧Vpc at any time, when the voltage on the source line Sj equals the data voltage Vd3, the gate voltage of the driver TFT Q1 rises, keeping the driver TFT Q1 turned off. As a result, The gate voltage of the driver TFT Q1 equals Vp+Vth+Vγ as in embodiment 1.

The third period, or the drive period, for the pixel circuit Aij starts at time 36t1. At the same time, the voltage on the voltage line Ui is changed from Vp to Vp−Va, switching the control line Ri to GL.

The gate voltage of the driver TFT Q1 changes from Vp+Vth+Vγ to Vp+Vth+Vγ−Va. If Vγ−Va≧0, the driver TFT Q1 is turned off. If Vγ−Va<0, the driver TFT Q1 is turned on. The current Ids through the driver TFT Q1 is

Ids=k×(Vγ−Va)²

as in embodiment 1.

In this manner, according to the present embodiment, the current Ids fed from the driver TFT Q1 to the OLED EL1 is determined through change in the voltage on the source line Sj (i.e., Vdk−Vpc) and change in the voltage on the voltage line Ui (i.e., −Va), independently of the threshold voltage Vth of the driver TFT Q1.

Accordingly, even if the RGB colors need different currents, that situation can be handled by adjusting the individual voltages Vdk fed to the RGB pixels.

FIG. 16 shows results of simulation of the current Ids based on properties of an OLED (GL=−4 V, GH=12 V, Vcom=0 V, Vp=12 V, Vpc=0 V, Va=2 V, Vda=2 V, 12 V, C1=500 fF, and C2=100 fF).

The current Ids(1) corresponds to the pixel circuit A11 and to a case where the absolute value of the threshold voltage Vth of the driver TFT Q1 is a minimum (=Vth(min)) and the mobility μ is a maximum. The current Ids(2) corresponds to the pixel circuit Aim and to a case where the absolute value of the threshold voltage Vth of the driver TFT Q1 is a maximum (=Vth(max)) and the mobility μ is a minimum. The current Ids(3) corresponds to the pixel circuit A(i+1)1 and to a case where the absolute value of the threshold voltage Vth of the driver TFT Q1 is a maximum (=Vth(max)) and the mobility μ is a minimum. The current Ids(4) corresponds to pixel circuit A(i+1)m and to a case where the absolute value of the threshold voltage Vth of the driver TFT Q1 is a minimum (=Vth(min)) and the mobility μ is a maximum.

From the results of the simulation in FIG. 16, the current Ids(1) equals about −1.33 μA, the current Ids(2) about −1.15 μA, the current Ids(3) about −1.11 μA, and the current Ids(4) about −1.27 μA.

One select period is 4t1, and 1t1 equals 2 μs in FIG. 16. It is 2t1 of each select period that the source line Sj changes from the reset voltage Vpc to the data voltage Vda. In the case, the current Ids for the pixel circuit Aij varies from −1.11 μA to −1.33 μA. This is an improvement over the variations in FIGS. 4, 8, and 11.

In this manner, the source lines Sj change from Vpc to the data voltage Vdk preferably at the same time.

Time division is preferably employed for grayscale display as in the display device 21 in FIG. 12 to construct such a source driver circuit from CG silicon TFTs and low-temperature polysilicon TFTs, because the time division scheme allows for simple source driver circuits and yield improvement.

If the source driver circuit is provided as an external IC, there is no need to pay attention to yield even if the analog voltages Vda fed to the source lines Sj are to be changed at the same timing. It is preferable to use analog grayscale because the scheme produces no dynamic false contours.

In any case, by using the pixel circuit Aij in FIG. 14, a current flow can be set up from the driver TFT Q1 to the OLED EL1 with three TFTs and two capacitors. The embodiment contains a reduced number of elements per pixel over conventional art and achieves an increased aperture ratio when applied to a bottom emission structure. Also, the embodiment allows for extending the lifetime of the OLED. In addition, the embodiment provides a display device with an increased resolution when applied to a top emission structure.

### EMBODIMENT 5

The following will describe embodiment 5 in reference to FIGS. 21 to 24.

First, FIG. 21 shows the structure of a pixel circuit Aij for the present embodiment. Specifically, the pixel circuit in FIG. 21 is identical to the pixel circuit of embodiment 1 shown in FIG. 1, except that the capacitor C2 is replaced by a switching TFT (fourth switching element) Q8 and a capacitor (second capacitor) C5 connected in series. The switching TFT Q8 is an n-type TFT.

In the pixel circuit in FIG. 1, the gate voltage of the driver TFT Q1 fluctuates in the first period due to the effect of the data voltage Vda fed to the data line Sj.

An actual simulation of the vibration demonstrates that the vibration affects the current output of the driver TFT (driver transistor) Q1, forcing it fluctuate by a few percent.

Accordingly, the switching TFT Q8 is added between the capacitor C5 and the source line (data line) Sj as shown in FIG. 21. The control line Gi is connected to the gate of the switching TFT Q8. In FIG. 21, the switching TFT Q8 is added to the source line side; it may added to the current output terminal side of the driver TFT (driver transistor) Q1.

The pixel circuit Aij in FIG. 21 is otherwise constructed of the same members as those described in embodiment 1. Description thereof is omitted.

A display device of the present embodiment has the same block arrangement as the display device 1 of embodiment 1. Description thereof is omitted.

The switching TFT Q8 is ON in part of the first period when the source line Sj is fed with the reset voltage Vpc and the second period, as could be appreciated from 4) Gi in the timing chart in FIG. 22. Besides, voltages are supplied to 1) the voltage line Ui, 2) the control line Wi, 3) the control line Ri, 5) the source line S1, and 6) the source line Sm for the i-th row on which the pixel circuit Aij resides, at the same timings as in embodiment 1 illustrated in FIG. 3.

The pixel circuit Aij is in a threshold correction period from time 0 to time 24t1 and in a drive period from time 24t1 onwards. In addition, the threshold correction period is divided into the first period (time 0 to time 16t1) and the second period (time 16t1 to time 24t1). The second period may be referred to as a select period. The drive period may be referred to as the third period.

The voltage line Ui is set to Vp (the predetermined voltage is the power supply voltage Vp in the present embodiment) at time 0 to start the first period of the threshold correction period for the pixel circuit Aij. Furthermore, the control line Gi is set to GH, turning on the switching TFT Q8. At time 0, the control line Wi is GH, and the control line Ri is GL. Therefore, the switching TFT Q2 is OFF, and the switching TFT Q3 is ON.

Next, the control line Wi is set to GL at time t1, turning on the switching TFT Q2 and short-circuiting the gate and drain of the driver TFT Q1. Since the switching TFT Q3 is also ON, The gate voltage of the driver TFT Q1 thus approaches the voltage Vcom of the common cathode Vcom, turning on the driver TFT Q1.

Next, the control line Ri is set to GH at time 2t1, turning off the switching TFT Q3. That obstructs the current flowing from the source via drain of the driver TFT Q1 to the OLED EL1. The current diverts flowing from the drain to the gate, raising the gate voltage.

The gate voltage continues to rise until the gate voltage reaches the threshold voltage. The data voltage Vda fed to the source lines S1 to Sm is prevented from affecting by making the control line Gi equal to GL at time 3t1, which turns off the switching TFT Q8.

The control line Gi is GH, and the switching TFT Q8 is turned on, from time 8t1 to time 11t1 when reset voltage Vpc is applied to the source line Sj. This way, the threshold correction is done in which the gate of the driver TFT Q1 reaches the threshold voltage when the source line side terminal of the capacitor C5 is Vpc.

In this manner, the switching TFT Q8 is turned on, to always maintain the source line side terminal of the capacitor C5 at Vpc, only in the period when the reset voltage Vpc is being applied to the source line Sj. That prevents the data voltage Vda from affecting the source line Sj.

The second period (select period) of the threshold correction period starts for the pixel circuit Aij at time 16t1. In the select period, the source line Sj is used to set up a drive current for the OLED EL1 in the pixel circuit Aij. At time 16t1, the voltages on the voltage line Ui and the control lines Wi and R1 are the same as they were when the driver TFT Q1 entered the threshold state in the first period. From time 19t1 to 21t1, the data voltages Vda corresponding to the display data Da for the sequentially pixels Aij are applied to the source lines S1 to Sm.

Since Vda≧Vpc at any time, when the voltage on the source line Sj equals Vda, the gate voltage of the driver TFT Q1 rises (or maintained), keeping the driver TFT Q1 turned off. As a result, change in the gate voltage of the driver TFT Q1 is dictated by the ratio of the capacitances of the capacitors C1 and C5 and the difference between the data voltage Vda and the reset voltage Vpc.

As a result, the gate voltage of the driver TFT Q1 equals Vp+Vth+Vγ as in embodiment 1.

The control line Wi is set to GH at time 23t1, turning off the switching TFT Q2. The third period, or the drive period, starts at time 24t1. At the same time, the voltage on the voltage line Ui is changed from Vp to Vp−Va, switching the control line Ri to GL, which in turn turns on the switching TFT Q3. At this time, the control line Gi is GL, and the switching TFT Q8 is turned off. That is not necessarily so.

As a result, The gate voltage of the driver TFT Q1 equals Vp+Vth+Vγ−Va as in embodiment 1.

FIG. 23 shows results of a simulation as to how the output current of the driver TFT (driver transistor) Q1 changes due to the switching TFT Q8.

FIG. 23 shows results of simulation of the current Ids based on properties of an OLED (GL=−4 V, GH=12 V, Vcom=0 V, Vp=12 V, Vpc=0 V, Va=2 V, Vda=5 V, Cl=500 fF, and C2=500 fF). The threshold correction period (first period) for each pixel Aij in the simulation is five select periods long.

FIG. 24 shows results of a simulation under the same conditions, except that no switching TFT Q8 is provided (the capacitor C5 directly connects to the direct source line Sj).

The current Ids(1) corresponds to the pixel circuit A11 and to a case where the absolute value of the threshold voltage Vth of the driver TFT Q1 is a minimum (=Vth(min)) and the mobility μ is a maximum. The current Ids(2) corresponds to the pixel circuit Aim and to a case where the absolute value of the threshold voltage Vth of the driver TFT Q1 is a maximum (=Vth(max)) and the mobility μ is a minimum.

From the results of the simulation in FIG. 23, the current Ids(1) equals −1.15 μA, and the current Ids(2) −0.92 μA. In contrast, from the results of the simulation in FIG. 24, the current Ids(1) equals −1.56 μA, and the current Ids(2) −1.19 μA.

In this manner, it would be appreciated that the provision of the switching TFT Q8 reduces the fluctuation of the output current Ids of the driver TFT Q1.

The pixel circuit Aij in FIG. 21 contains a reduced number of elements per pixel over conventional art and achieves an increased aperture ratio when applied to a bottom emission structure. Also, the embodiment provides a display device with an increased resolution when applied to a top emission structure.

### EMBODIMENT 6

The following will describe embodiment 6 in reference to FIGS. 25 to 27.

In embodiments 1 to 5, a capacitor (second capacitor) is provided between the drain (current output terminal) of the driver TFT (driver transistor) Q1 and the source line (data line) Sj.

However, the means of the present invention is effective even when a capacitor (second capacitor) and a switching TFT are provided between the gate (current control terminal) of the driver TFT (driver transistor) Q1 and the source line (data line) Sj.

Accordingly, the present embodiment employs a configuration in which there are a capacitor (second capacitor) C6 and a switching TFT (fourth switching element) Q9 connected in series between the gate (current control terminal) of the driver TFT Q1 and the source line (data line) Sj as shown in FIG. 25. This is the same configuration of embodiment 5 shown in FIG. 21, except that the capacitor C5 of the pixel circuit connects to the gate, instead of the drain, of the driver TFT Q1.

The switching TFT Q9 is a n-type TFT. Its gate is connected to a control line Gi. In FIG. 25, the capacitor C6 and the switching TFT Q9 are connected in series so that the switching TFT Q9 is placed on the source line side. This is not the only possibility. The series circuit may be arranged so that the switching TFT Q9 is placed the gate side (current control terminal side) of the driver TFT (driver transistor) Q1.

The pixel circuit Aij in FIG. 25 is otherwise constructed of the same member as those described in embodiment 1. Description thereof is omitted.

A display device of the present embodiment has the same block arrangement as the display device 21 of embodiment 4. Detailed description thereof is omitted here.

FIG. 26 shows a timing chart for the pixel circuit. FIG. 26 shows timings of voltage supply to 1) the voltage line Ui, 2) the control line Wi, 3) the control line Ri, 4) the control line Gi, 5) the source line Sj, and 6) the voltage line Ui+1 for the i-th row on which the pixel circuit Aij resides, and to 7) the control line Wi+1, 8) the control line Ri+1, and 9) the control line Gi+1 for the (i+1)-th row on which the pixel circuit A(i+1)j resides.

The pixel circuit Aij is in a threshold correction period from time 0 to time 24t1 and in a drive period from time 24t1 onwards. In addition, the threshold correction period is divided into the first period (time 0 to time 18t1) and the second period (time 18t1 to time 24t1). The second period may be referred to as a select period. The drive period may be referred to as the third period.

The voltage line Ui is set to Vp (the predetermined voltage is the power supply voltage Vp in the present embodiment) at time 0 to start the first period of the threshold correction period for the pixel circuit Aij. Furthermore, the control line Wi is GL, and the switching TFT Q2 is ON. The control line Ri is GL at time 0. Therefore, the switching TFT Q3 is ON.

That short-circuits the gate and drain of the driver TFT Q1. Since the switching TFT Q3 is also ON, the gate voltage of the driver TFT Q1 approaches the voltage Vcom of the common cathode Vcom, turning on the driver TFT Q1.

Furthermore, the control line Gi is GH, and the switching TFT Q9 is ON. Since the reset voltage Vpc is being applied to the source line Sj at this time, the reset voltage Vpc is being applied to the source line side terminal of the capacitor C6.

Next, the control line Ri is set to GH at time 2t1, turning off the switching TFT Q3. That obstructs the current flowing from the source via drain of the driver TFT Q1 to the OLED EL1. The current diverts flowing from the drain to the gate, raising the gate voltage.

The period, in the threshold correction period, in which an operation of turning the driver TFT Q1 into a threshold state while the reset voltage Vpc is being applied to the source line Sj lasts until the control line Wi is set to GH and the switching TFT Q2 is turned off at time 20t1.

The reset voltage Vpc and the data voltage Vda are sequentially applied to the source line Sj from time 2t1 to time 20t1. Since Vpc≦Vda at any time, however, the gate of the driver TFT Q1 reaches a threshold voltage while the reset voltage Vpc is being applied to the source line Sj. In addition, the gate of the driver TFT Q1 is an OFF voltage while the data voltage Vda is being applied to the source line Sj.

The second period, or the select period, for the pixel circuit Aij starts at time 18t1. First, at time 20t1, the control line Wi is set to GH, turning off the switching TFT Q2. Thereafter, the voltage on the source line Sj is set to Vda corresponding to the pixel Aij. At time 23t1, the control line Gi is set to GL, turning off the switching TFT Q9.

As a result, The gate voltage of the driver TFT Q1 equals Vp+Vth+Vγ as in embodiment 1.

Then, in the third period, or the drive period, the control line Ri is set to GL at time 24t1, turning on the switching TFT Q3. Also, the potential wire Ui is set to Vp−Va.

The gate voltage of the driver TFT Q1 changes from Vp+Vth+Vγ to Vp+Vth+Vγ−Va. If Vγ−Va≧0, the driver TFT Q1 is turned off. If Vγ−Va≦0, the driver TFT Q1 is turned on.

FIG. 27 shows results of a simulation as to how the output current of the driver TFT (driver transistor) Q1 changes.

FIG. 27 shows results of simulation of the current Ids based on properties of an OLED (GL=−4 V, GH=12 V, Vcom=0 V, Vp=12 V, Vpc=0 V, Va=2 V, Vda=5 V, C1=500 fF, and C2=500 fF). The threshold correction period (first period) for each pixel Aij in the simulation is seven select periods long.

The current Ids(1) corresponds to the pixel circuit Ai1 and to a case where the absolute value of the threshold voltage Vth of the driver TFT Q1 is a minimum (=Vth(min)) and the mobility μ is a maximum. The current Ids(2) corresponds to the pixel circuit Aim and to a case where the absolute value of the threshold voltage Vth of the driver TFT Q1 is a maximum (=Vth(max)) and the mobility μ is a minimum.

From the results of the simulation in FIG. 27, the current Ids(1) equals −0.80 μA, and the current Ids(2) −0.55 μA.

In this manner, it would be appreciated that the present embodiment enables setting up of the current Ids fed from the driver TFT Q1 to the OLED EL1, independently of the threshold voltage Vth of the driver TFT Q1, even in the structure in which the capacitor (second capacitor) C6 and the switching TFT (fourth switching element) Q9 are connected in series to the gate (current control terminal) of the driver TFT Q1.

In addition, the embodiment involves three switching TFTs and four TFTs, which is one fewer switching TFTs than conventional art. The embodiment thus includes a reduced number of elements per pixel. The embodiment achieves an increased aperture ratio when applied to a bottom emission structure. Also, the embodiment allows for extending the lifetime of the OLED. In addition, the embodiment provides a display device with an increased resolution when applied to a top emission structure.

The foregoing has described the embodiments. The embodiments have assumed that the electro-optical elements in the display device are OLEDs. This is not the only possibility. The present invention is applicable those display devices which uses the emission sections of FEDs or semiconductor LEDs as the electro-optical elements.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The invention is suitable for applications in OLED display, FEDs, and other like display devices using current-driven elements.

1. A display device, comprising:
a plurality of pixels arranged in a matrix;
driver transistors, one for each pixel, each for supplying an output current as a drive current from a current output terminal to a current-driven electro-optical element, the output current being controlled by a voltage on a current control terminal referenced to a reference voltage terminal connected to the electro-optical element and a power supply line;
first voltage lines for each outputting a first voltage; and
data lines for each outputting a data voltage corresponding to display data for an associated one of the pixels,
wherein
the pixels each includes:
a first capacitor connected between the current control terminal of an associated one of the driver transistors and an associated one of the first voltage lines;
a first switching element connected between the current control terminal of that driver transistor and the current output terminal; and
a second capacitor connected between the current output terminal of the driver transistor and an associated one of the data lines.

2. The display device of claim 1, executing:
a first period in which a voltage on the data line is set to a reset voltage, while maintaining the first voltage on the first voltage line at a predetermined voltage and the first switching element closed, and the voltage on the current control terminal of the driver transistor is set to a voltage at which the driver transistor is in a threshold state in which the output current of the driver transistor either starts or stops flowing;
a second period, immediately preceded by the first period, in which the voltage on the data line is set to the reset voltage and then to the data voltage; and
a third period, immediately preceded by the second period, in which the voltage on the current control terminal is controlled so that the electro-optical element emits light.

3. The display device of claim 2, wherein:
the first switching element is opened in the second period while the voltage on the data line is being equal to the data voltage, so as to enter the third period; and
the first voltage on the first voltage line is changed from the predetermined voltage in the third period so as to control the voltage on the current control terminal.

4. The display device of claim 1, wherein the current output terminal of the driver transistor and the electro-optical element are connected via a second switching element.

5. The display device of claim 1, wherein:
the current output terminal of the driver transistor is connected to one of two terminals of the electro-optical element; and
the other terminal of the electro-optical element is connected to a second voltage line which outputs a second voltage.

6. The display device of claim 1, wherein a third switching element is connected parallel to the second capacitor.

7. A method of driving the display device of claim 1, comprising the steps of:
executing a first period in which a voltage on the data line is set to a reset voltage, while maintaining the first voltage on the first voltage line at a predetermined voltage and the first switching element closed, and the voltage on the current control terminal of the driver transistor is set to a voltage at which the driver transistor is in a threshold state in which the output current of the driver transistor either starts or stops flowing;
executing a second period, immediately preceded by the first period, in which the voltage on the data line is set to the reset voltage and then to the data voltage; and
executing a third period, immediately preceded by the second period, in which the voltage on the current control terminal is controlled so that the electro-optical element emits light.

8. The method of claim 7, wherein:
the first switching element is opened in the second period while the voltage on the data line is being equal to the data voltage, so as to enter the third period; and
the voltage on the first voltage line is changed from the voltage on the power supply line in the third period so as to control the voltage on the current control terminal.

9. The display device of claim 1, wherein a fourth switching element is connected in series with the second capacitor.

10. The display device of claim 9, wherein the fourth switch is opened in the first period while the data voltage is being equal to the voltage on the data line.

11. A display device, comprising:
a plurality of pixels arranged in a matrix;
driver transistors, one for each pixel, each for supplying an output current as a drive current from a current output terminal to a current-driven electro-optical element, the output current being controlled by a voltage on a current control terminal referenced to a reference voltage terminal connected to the electro-optical element and a power supply line;
the first voltage lines for each outputting a first voltage; and
data lines for each outputting a data voltage corresponding to display data for an associated one of the pixels,
wherein
the pixels each includes:
a first capacitor connected between the current control terminal of an associated one of the driver transistors and an associated one of the first voltage lines;
a first switching element connected between the current control terminal of that driver transistor and the current output terminal; and
a second capacitor and a fourth switching element connected in series between the current control terminal of the driver transistor and an associated one of the data lines.

12. The display device of claim 11, executing:
a first period in which a voltage on the data line is set to a reset voltage, while maintaining the first voltage on the first voltage line at a predetermined voltage and the first and fourth switching elements closed, and the voltage on the current control terminal of the driver transistor is set to a voltage at which the driver transistor is in a threshold state in which the output current of the driver transistor either starts or stops flowing;
a second period, immediately preceded by the first period, in which the voltage on the data line is set to the reset voltage, the first switching element is opened, thereafter the voltage on the data line is set to the data voltage, and the fourth switching element is opened;
a third period, immediately preceded by the second period, in which the voltage on the first voltage line is changed from a voltage on the power supply line, and the voltage on the current control terminal is controlled so that the electro-optical element emits light.

13. The display device of claim 2, wherein the reset voltage for the data line is either not lower than the data voltage at any time or not higher than the data voltage at any time.
